(19) United States
(12) Patent Application Publication
(10) Pub. No.: US 2026/0042258 A1
(43) Pub. Date: Feb. 12, 2026

(54) WEB-BASED COMPOSITE-BASED ADDITIVE MANUFACTURING (CBAM) SYSTEM AND METHOD, WITH CONTROLLED SHEET REGISTRATION

(71) Applicant: IMPOSSIBLE OBJECTS, INC., Northbrook, IL (US)

(72) Inventors: Robert D. Swartz, Highland Park, IL (US); Eugene Gore, Wilmette, IL (US); Alex S. Brougham, Webster, NY (US); Carl R. Burkhard, Rochester, NY (US); Jess R. Genter, Rochester, NY (US); Stephen P. Hoover, Rochester, NY (US); Jack T. LeStrange, Macedon, NY (US); Christopher G. Lynn, Wolcott, NY (US); Joseph C. Sheflin, Macedon, NY (US); Timothy G. Shelhart, West Henrietta, NY (US)

(73) Assignee: IMPOSSIBLE OBJECTS, INC., Northbrook, IL (US)

(21) Appl. No.: 19/248,107

(22) Filed: Jun. 24, 2025

Related U.S. Application Data
(60) Provisional application No. 63/663,372, filed on Jun. 24, 2024.

(51) Int. Cl. B29C 64/336; B29C 64/165; B29C 64/209; B29C 64/214; B29C 64/35; B33Y 10/00; B33Y 30/00; B33Y 40/10; B33Y 70/10

(52) U.S. Cl. CPC B29C 64/336; B29C 64/165; B29C 64/209; B29C 64/214; B29C 64/35; B33Y 10/00; B33Y 30/00; B33Y 40/10; B33Y 70/10

(57) ABSTRACT

A web-based CBAM printing system and method comprises a machine and improvements therein that permit accurate image-to-edge registration for printed cross-sectional layers, simultaneously with edge-to-edge registration among sheets that make up a build block, all in combination with high-precision edge cutting of the web and bow-prevention structures to facilitate stacking.

### CROSS REFERENCE TO RELATED APPLICATION

This application claims the benefit of priority of U.S. provisional application No. 63/663,372, filed Jun. 24, 2024, the contents of which are herein incorporated by reference.

### BACKGROUND OF THE SUBJECT DISCLOSURE

The present invention relates to additive manufacturing, and more particularly a form of additive manufacturing known as Composite Based Additive Manufacturing (CBAM).

Applicant pioneered CBAM. Applicant's CBAM innovations include those described and/or claimed in the following United States patents (each of which is hereby incorporated by reference in its entirety): U.S. Pat. Nos. 9,393,770, 9,776,376, 9,827,754, 9,833,949, 10,046,552, 10,252,487, 10,350,877, 10,377,080, 10,377,106, 10,384,437, 10,597,249, 10,751,987, 10,934,120, 10,946,592, 10,967,577, 11,040,490, 11,084,134, 11,173,546, 11,370,166, 11,413,790, 11,413,821, 11,584,080, 11,667,081, 11,673,320, 11,673,336, 11,674,207, 11,679,601, 11,806,931, 11,806,935, 11,904,532, 11,904,536, 11,904,549, 11,969,938, 11,969,954, 11,970,584. Before now, physical implementations of Applicant's innovations existed on sheet-based (rather than web-based) machines. In scaling up to high performance machines that go faster and can make bigger parts, Applicant devised numerous improvements.

Composite based additive manufacturing is a 3D printing technology that relies on a combination of materials to construct a final 3D article. In typical application, the primary materials (or consumables) used in CBAM are (1) a veil or substrate material (e.g., thin sheets or alternatively rolls, also known as webs, any of which can be made from nonwoven carbon fiber or fiberglass held together with a suitable binder), (2) an ink in the form of a usually-clear liquid that is precision printed onto desired areas of the substrate material, and (3) powder which can be thermoplastic such as polyamide (PA) 12, polyethylene terephthalate (PET), polypropylene, polyetheretherketone (PEEK), polyaryletherketone (PAEK), thermoset, or metal-flux mixtures.

In practice, a computer model has divided an intended 3D object into cross-sectional slices. The positive areas of a given cross section are printed with high precision using ink (typically through inkjet heads) onto a layer of the substrate material. That printed layer is then flooded with powder so that powder adheres to the printed areas representing the object's cross section but does not adhere to the unprinted areas. Then excess powder is removed (e.g., via vacuum). Sheets of such printed and powdered layers are then stacked in high precision registration so that adjacent cross-sectional layers of the intended 3D object exist on adjacent stacked sheets (which to this point still includes surrounding unprinted and unpowdered substrate material). Precise sheet to sheet registration is critical to the CBAM process and is not practiced in conventional graphic arts processes since it is not required. This adds significant difficulty over conventional graphic arts processes. The final registered stack (or build block) is then pressed in a press jig. Either simultaneously or subsequently to such pressing action, the build block is heated to a temperature sufficient to melt the powder and cause its flow into adjacent layers. The melted and fused build block is then cooled so that the flow hardens.

The powder material thus surrounds and becomes a “composite” with the substrate material (e.g., PEEK melting and flowing around individual carbon fibers, then cooling to make a sturdy carbon fiber composite). This hardened material (embedded inside the build block) represents the 3D shape of the intended 3D object because of the precision printing and registration that had occurred earlier. A subsequent step removes the unprinted/unpowdered/unhardened areas of the build block, for example through sandblasting abrasion or dry ice blasting of relatively friable carbon fiber. Alternatively, as described by the referenced patents, chemical removal is used for appropriate materials. After the substrate removal step, the computer model's 3D object now exists as a physical article made of material having the desired properties (e.g., carbon fiber composites suitable for automotive, aerospace or electronics-assembly applications).

What is needed is a web-based CBAM system and method, and resulting articles of manufacture, that permit accurate image-to-edge registration for printed cross-sectional layers, simultaneously with edge-to-edge registration among sheets that make up a build block, while maintaining the speed inherent to web transport of substrate material.

### SUMMARY OF THE SUBJECT DISCLOSURE

A web-based CBAM printing system and method comprises an advanced and improved machine, capable of achieving bigger, better and faster CBAM parts. The systems and methods described herein permit accurate image-to-edge registration for printed cross-sectional layers, simultaneously with edge-to-edge registration among sheets that make up a build block. In one aspect of the present subject disclosure,

In one aspect of the subject disclosure, an apparatus for composite-based additive manufacturing includes an unwinding station that feeds a web of substrate material from a roll at a controlled speed along a process direction using at least one powered roller. Downstream, an edge and corner alignment module ensures proper registration, followed by a printing, powdering, and vacuuming station for applying cross-sectional images and fiducial marks, depositing powder, and removing excess material. A cutting station positioned downstream of the printing station severs the web into sheets with cuts made along an inboard-outboard direction, and a stacking station deposits the sheets into a stack while a tamper adjusts the most recently deposited sheet to maintain edge and corner registration. In various embodiments, the alignment module incorporates a belt steering system with an edge sensor and a controlled actuator for lateral adjustment, a web cleaning system to remove loose fibers, a load cell system with a movable roller to measure web tension, and a roller surface encoder to monitor web velocity. Other variations include a printing module comprising a camera edge sense system, a page-wide inkjet head system for continuous image printing, a powder deposition system with a smoothing blade for even powder distribution, and a vacuum system paired with a scanner camera for quality control, as well as an embodiment with staggered inkjet heads designed to overlap output regions for defect correction and additional features such as a fresh-powder container with a vacuum nozzle operating in a spiral path controlled by a powder-level sensor.

In another aspect of the subject disclosure, the apparatus for composite-based additive manufacturing features an intermittent powered roller that advances the substrate web; a sensor to detect fiducial marks; and a cutter that severs the web into individual sheets upon receiving a signal from the sensor. An accumulator system buffers the web upstream during intermittent advancement, while a defect detection system inspects each substrate sheet and a rejection system diverts defective sheets—or intervening sheets until a correct replacement appears—to maintain a proper sequence. A stacking station subsequently deposits the nondefective substrate sheets into a stack, with a tamper ensuring edge-to-edge and corner registration. In some embodiments, the stacking station includes stacker disks with variable slot angles to reduce sheet bowing, an elevator system that lowers the support surface during stacking, and additional components such as dancer rollers and tension sensors to maintain and control web tension. A controller coordinates the sequence of advancement, cutting, defect detection, rejection, and stacking, and may further initiate reprinting of defective sheets while ensuring proper order is maintained through detection systems that actuate stacker disks upon sensing a trailing edge.

A further aspect of the subject disclosure provides a method for continuous composite-based additive manufacturing. This method includes feeding a web of substrate material from a roll at a controlled speed along a process direction, aligning the lateral position of the web via a combination of powered and passive rollers along with a belt steering system to maintain edge alignment, and measuring web tension with a load cell system that incorporates a movable roller. The velocity of the web is monitored with a roller surface encoder, and a camera edge sense system detects an edge of the web to provide feedback for precise image placement. The method then continuously prints cross-sectional images and fiducial marks using an inkjet head system, applies powder using a dedicated deposition system, and captures images for quality control and defect detection via a scanner camera system. Subsequently, the web is cut into individual sheets—each carrying an image and fiducial mark—and the sheets are deposited onto a stack using a tamper to ensure accurate edge and corner registration. In various embodiments, the method further comprises removing loose fibers with a web brush, distributing powder uniformly with a smoothing blade, and cleaning or compensating for malfunctions in the inkjet head system based on captured image data.

In another aspect of the subject disclosure, the manufacturing process comprises detecting a fiducial mark printed on the substrate web via an upstream sensor, causing an intermittent powered roller to pause web advancement and actuate a cutter that severs the web into individual substrate sheets. An accumulator system buffers the web upstream during these pauses. Each sheet is then inspected using a defect detection system, and any defective substrate sheet is replaced by a first reprinted sheet, with additional reprinted sheets generated if necessary to maintain the correct sequence. The defective sheet and any out-of-sequence sheets are diverted by a rejection system. Nondefective substrate sheets are advanced to a stacking station where they are deposited into a stack with edge-to-edge and corner registration maintained by a tamper, after which the registered stack is transferred to a press jig assembly station where compressive force and heat fuse the sheets into a build block. Further process steps may include removing unprinted or unpowdered areas and, in some embodiments, lowering the support surface with an elevator, maintaining web tension with dancer rollers and sensors, or actuating stacker disks upon detection of the substrate sheet's trailing edge, while ensuring that web and sheet transport avoid contact with printed areas.

An additional aspect of the subject disclosure is directed to a composite-based additive manufacturing arrangement system. This arrangement comprises a continuous roll of substrate material; an edge alignment module featuring an edge sensor and belt steering system; a roller surface encoder; an inkjet printing module; a powder deposition module coupled with a smoothing blade mechanism; a controlled vacuum module for removing excess powder; and a fiducial mark sensor. The arrangement further incorporates an intermittent powered roller, an accumulator system, and a pneumatic cutter for severing the web into individual substrate sheets. A stacking station equipped with a tamper ensures edge and corner registration of the deposited sheets, and a press jig assembly module receives the registered stack. A processor or controller, in conjunction with memory storing relevant instructions, directs the unwinding of the substrate web at a predetermined speed, adjusts the lateral position based on edge sensor data, controls the inkjet printing module based on web velocity data, operates the powder deposition and vacuum modules, detects fiducial marks to trigger intermittent advancement and cutting, coordinates stacking operations for precise sheet registration, and transfers the registered stack to the press jig assembly module for further processing into a composite-based three-dimensional object.

These and other features, aspects and advantages of the present subject disclosure will become better understood with reference to the following drawings, description and claims.

### BRIEF DESCRIPTION OF THE DRAWINGS

FIG. 1 is a plan view of a high performance CBAM machine showing its stages from unwinding through the press jig assembly station.

FIG. 2A is view of the unwinding station as-equipped with a web.

FIG. 2B is a schematic view of the unwinding station of FIG. 2A.

FIG. 2C is a view of part of a disassembled unwinding station.

FIG. 3A is a view of the edge alignment and tensioning station as-equipped with a web.

FIG. 3B is a schematic view of the edge alignment and tensioning station.

FIG. 4A-1 is a view of the printing, powdering and vacuuming station as-equipped with a web and one of two powder stations.

FIG. 4A-2 is another view of the printing, powdering and vacuuming station as-equipped with a web and one of two powder stations.

FIG. 4B is a schematic view of the printing, powdering and vacuuming station with two powder stations.

FIG. 4C is a view of part of a disassembled printing, powdering and vacuuming station.

FIG. 4D is a view of the camera edge sense system of the printing, powdering and vacuuming station.

FIG. 4E is a view of the screw transport that delivers powder to the paddle of FIG. 4F.

FIG. 4F is a view of the powder paddle that receives powder from the screw transport.

FIG. 4G is a view of a powder supply feeder that vacuums fresh powder into a cyclone.

FIG. 4H is another view of a powder supply feeder that vacuums fresh powder into a cyclone.

FIG. 5A is a view of the cutting station as-equipped with a web.

FIG. 5B is a schematic view of the cutting station.

FIG. 5C is a view of part of a disassembled cutting station.

FIG. 6A a view of the pre-stacker transport and stacking station as-equipped with a web.

FIG. 6B is a schematic view of the pre-stacker transport and stacking station, as well as the press jig assembly station.

FIG. 6C is a view of part of a disassembled pre-stacker transport and stacking station.

FIG. 6D is a view of the discard system of the pre-stacker transport system.

FIGS. 6E and 6F are two opposite sides of part of a sheet disk showing the variable slot angle along part of the circumference.

FIG. 6G is a view from below of the elevator system within the stacking station.

FIG. 6H is a view from above in a partially disassembled stacker unit at the location where the sheet disks would be, showing the tampers that facilitate registered stacking.

FIG. 6I is a view showing the initial stage of the stacker disks transporting a printed sheet toward the stacking position.

FIG. 6J is a view showing the stacker disks advancing the printed sheet further toward the stack.

FIG. 6K is a view showing the printed sheet being deposited onto the stack by the stacker disks.

FIG. 6L is a view showing the completion of the stacking operation by the stacker disks.

FIG. 6M is a view demonstrating movement of the tampers, with the tampers shown in an exaggerated extended condition, in phantom, for clarity.

FIG. 7A is a view of the press jig assembly station.

FIG. 7B is a view of part of a disassembled press jig assembly station.

FIG. 7C is a view illustrating the initial position of the stack as it is prepared for movement within the press jig assembly station.

FIG. 7D is a view showing the stack being advanced horizontally within the press jig assembly station.

FIG. 7E is a view showing further horizontal movement of the stack within the press jig assembly station.

FIG. 7F is a view showing the stack approaching the final position for lid installation.

FIG. 7G is a view showing the stack in position for lid installation within the press jig assembly station.

FIG. 7H is a view illustrating the beginning of the lid installation process on the jig.

FIG. 7I is a view showing the lid being lowered onto the stack within the jig.

FIG. 7J is a view showing the lid fully installed on the jig, covering the stack.

FIG. 8 is a view of a hand cart with fork for lifting and transporting the press jig.

FIG. 9A is a view of a bottom of a press equipped for receiving the press jig.

FIG. 9B is a view of a top of a press equipped for receiving the press jig.

FIG. 9C is a series of views illustrating the press applying compressive force to the press jig.

FIG. 10A is a view of an oven suitable for use with the present invention.

FIG. 10B is a perspective view of a substrate removal station.

FIG. 11 is a schematic view of the relationship between the main controller and the real-time controllers.

FIG. 12 is a flow chart illustrating the process for defect detection, discard, and reprinting of substrate sheets.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides a high-speed, high-precision composite-based additive manufacturing system. The system may include continuous web transport with edge-only registration, integrated multi-station automation with real-time correction, web-to-sheet transition mechanisms, bowing prevention during stacking, real-time quality control, dynamic press adjustment during cooling, and a modular multi-controller system architecture. These features address limitations in earlier CBAM systems and provide substantial technical and operational improvements.

The following detailed description of the preferred embodiments should be taken as exemplary and nonlimiting, except to the extent incorporated in language of the appended claims.

Embodiments of the present invention comprise a high-speed, high-performance version of CBAM including numerous improvements. Whereas past physical implementations of CBAM have deployed up to 12″×16″ fiber sheets, fiberglass or carbon for example, at the outset of the process, the present invention employs a series of fiber sheets, e.g., 20-inch square, formed from a web roll that are printed and powdered while in the web roll scrolls and subsequently cut to shape to facilitate registered stacking.

As a result of the near continuous scrolling of the web roll, the subject disclosure brings significant speed improvements (11,800 cm³/hr vs. 740 cm³/hr), while enabling construction of much larger 3D articles than previously possible because of the increased throughput.

And while past physical implementations of CBAM required physical alterations to the sheets to achieve precision registration (e.g., punched holes, laying sheets onto tapered registration pins), and required creative sheet-lifting and movement techniques to permit movement through various stages (e.g., felted grippers), embodiments of the present invention eliminate the need for in-process physical alterations to, or wholesale lifting of, substrate material.

Embodiments of the subject disclosure maintain material movement and proper tensioning through web control and achieve high-precision registration using only sheet edges aided by belt steering, precision cutting, variable frequency inkjet printing and machine vision control systems to ensure highly accurate image-to-edge placement. In the web based CBAM machine, registration is done by corner and edge registration, not pins, and the methods for doing this are described below. In corner and edge registration, typically a sheet is registered on a corner, so in this instance the image must be in the same place sheet to sheet and same place related to the corner.

The present invention thus embodies a new edge-registered, high-speed, high-performance CBAM system and method that resolve numerous issues that only first come apparent during attempts to construct such a web-based system.

### Stations

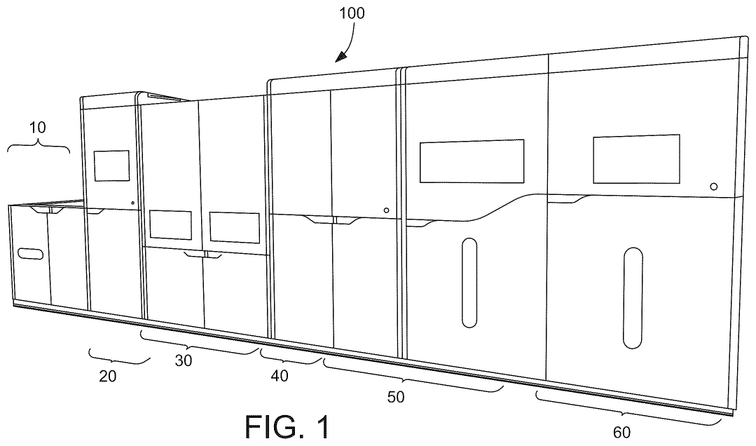

Embodiments of the present invention generally comprise nine stations where particular phases of CBAM activities are accomplished. With reference to FIG. 1, 9A, 9B and 10, the first six of these stations exist in the high-performance machine 100 itself, though the invention is not limited to such configurations. For example, it is possible to extend the machine of the present embodiments so that any of or all the three subsequent stations are incorporated into the same footprint, and movement between them is automated. Conversely, the web roll implementation described herein does not necessarily require any stage after cutting to exist in the same machine, and indeed cutting itself may be moved as far back as just after the unwinding station. (It is contemplated that alternative embodiments are within the level of ordinary skill wherein the web could be rewound, then cutting and stacking could be postponed and/or shifted to a separate process or machine.) In total, the nine stations of the current embodiment are: the unwinding station 10; the edge alignment station 20; the printing, powdering and vacuuming station 30; the cutting station 40; the pre-stacker transport and stacking station 50; the press jig assembly station 60 (items 10, 20, 30, 40, 50 and 60 making up the overall machine 100); the press station 900; the oven station 1000; and the substrate removal station (not shown, generally embodied as a sandblasting cabinet).

### 1. Unwinding Station

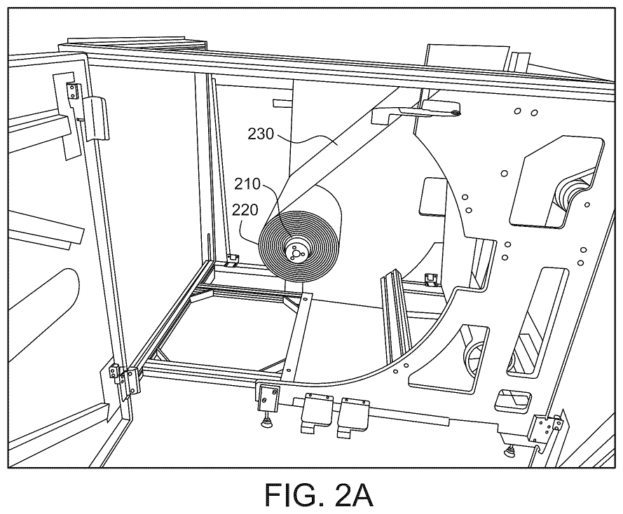

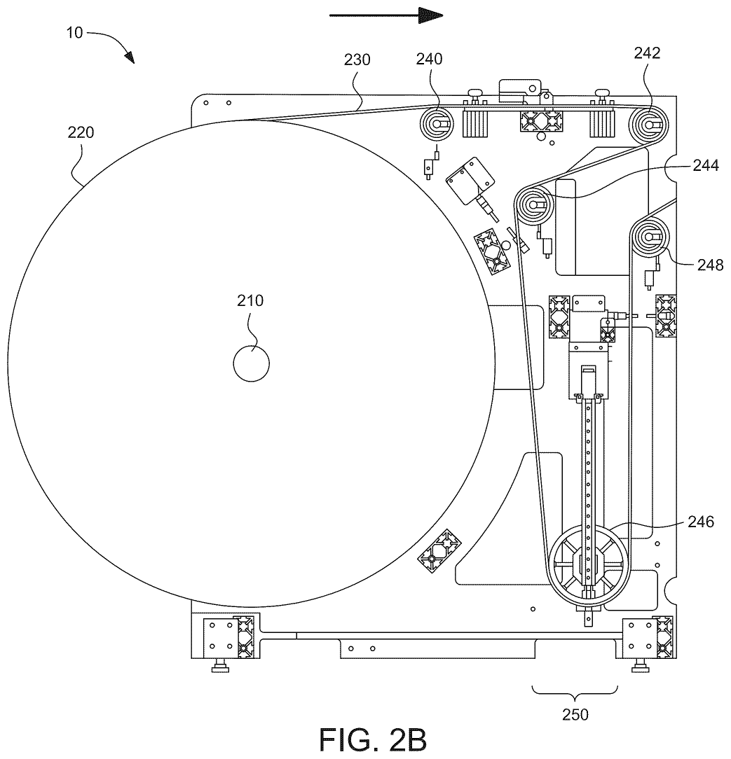

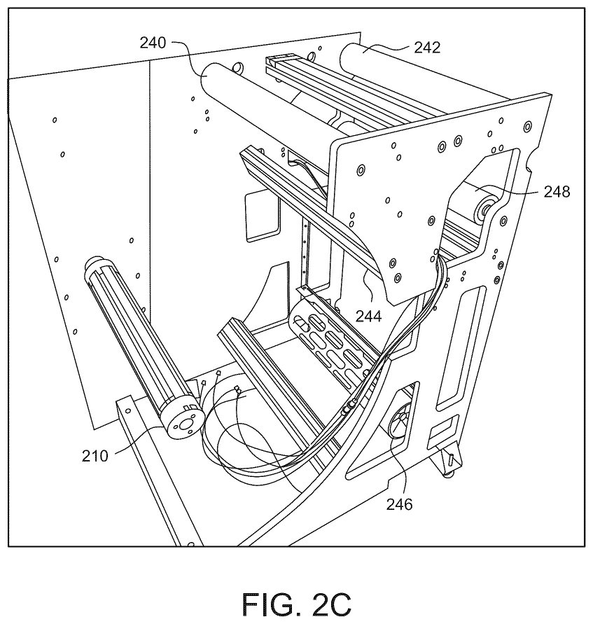

With reference to FIGS. 1, 2A, 2B and 2C, unwinding station 10 includes spindle 210 onto which web roll 220 is placed. Spindle 210 may include a pneumatically engaged chuck that expands to maintain frictional engagement with the interior of web roll 220. As web roll 220 unwinds through actions of machine 100, a flat surface of substrate material 230 (the veil or web) leaves the roll, in the process direction (as depicted by an arrow in FIG. 2B). Web roll 220 may comprise a fiber web roll that is at least eighteen inches or more across from the inboard to outboard direction.

There is a plurality of powered rollers in machine 100, housed within down-process stations (to be later described). Rollers 240, 242 and 244 deliver substrate material 230 passively toward disk 246 and subsequently to passive roller 248. Rollers 244 and 248 cooperate with disk 246 to form a dancer roller/accumulator loop 250, to maintain the tension of substrate material 230 as it travels through machine 100 at relatively constant velocity and maintain integrity of printing results. In general, the dancer roller acts as a tension sensing and control element, while the accumulator loop provides a buffer to handle variations in web speed or consumption. As substrate material 230 moves across passive roller 248, it now enters the edge alignment station 20.

### 2. Edge Alignment Station

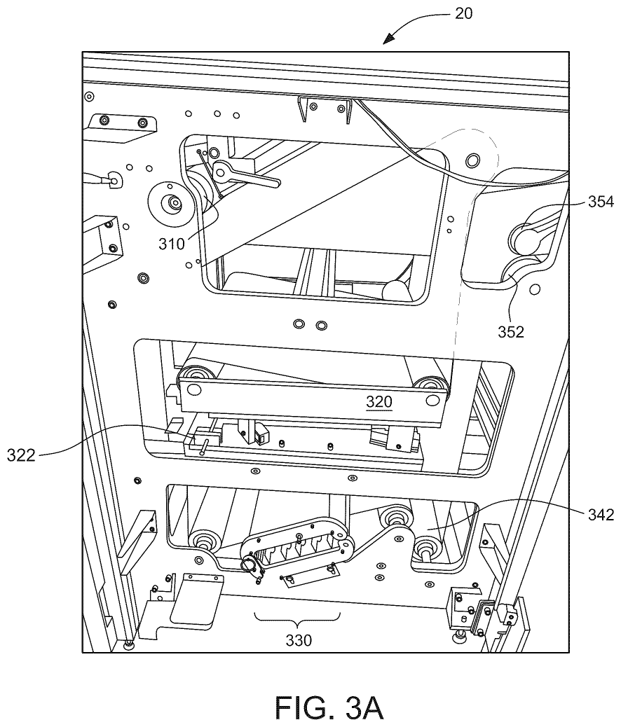

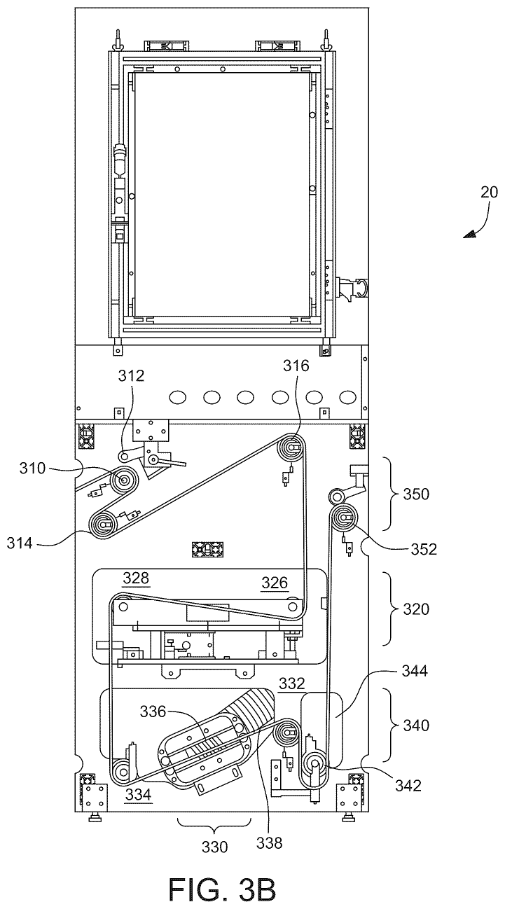

With reference to FIGS. 1, 3A and 3B, edge alignment station 20 receives substrate material 230 off passive roller 248 onto the first in the process direction powered roller 310. Powered roller 310 is accompanied by passive roller 312 to ensure proper contact, thereby permitting the friction-enhanced surface of powered roller 310 to grab without slippage. Substrate material 230 comes off powered roller 310 onto passive rollers 314 and 316 to result in a downward process direction downstream of roller 316.

At this point, substrate material 230 enters belt steering system 320. Belt steering system 320 includes optical edge array sensor 322 and a controlled axis which, in the present embodiments, is a powered vertical axis capable of rotating belt steering system 320 clockwise or counterclockwise, preferably up to 5-10°. Belt steering system 320 maintains controlled edge alignment of substrate material 230 on the various rollers. This is important to facilitate edge registration of the overall system, through each of the stations of machine 100. Belt steering system 320 includes passive rollers 326 and 328. Through the operation of the error-correcting control system, slight corrections can be achieved in placement of substrate material 230 on the rollers of the belt steering system 320 (and those downstream in the process direction).

Web brush system 330 receives substrate material 230 as it exits belt steering system 320. Web brush system 330 “pre-processes” the surface of substrate material 230 so that loose fibers can be removed. Between passive rollers 332 and 334, brushes 336 clean off loose fibers which then get vacuumed through hose 338.

Substrate material 230 enters load cell system 340 as it leaves web brush system 330. Load cell system 340 includes passive roller 342 whose axis is movably situated to assist load cell 344 in determining the real-time tension of substrate material 230, and to feed that determination back to a dedicated real-time controller. If the real-time controller determines tension correction is required, this may be achieved through slight temporary alterations of the relative speed of the first two powered rollers to create a temporary phase adjustment. As a result, substrate material 230 may become tighter or looser (as the case may be), and dancer roller/accumulator loop 250 may become used to take up or release slack.

Substrate material 230 moves upward in the present embodiment from load cell system 340 toward velocity sense system 350, which comprises passive roller 352 and roller surface encoder 354. Placement of velocity sense system 350 occurs as close as practical to inkjet printing, because it serves two roles. Sensed velocity from roller surface encoder 354 will be used by the main controller to maintain in general a near-constant speed of substrate material 230 in the process direction, through controlled drive of the two powered rollers. Separately, sensed velocity also serves as an input to the main controller's printing algorithms. Namely, small velocity deviations could potentially result in registration errors with images printing too close to, or too far from, what will become the future edge cut across the web at the cutting station. This can result in sheet-to-sheet registration errors with respect to the vertically adjacent images/slices. Sensed velocity can be used for digital registration correction with respect to such edges on an image-by-image basis, to correct for such small deviations, through inkjet head firing frequency-timing adjustments.

### 3. Printing, Powdering and Vacuuming Station

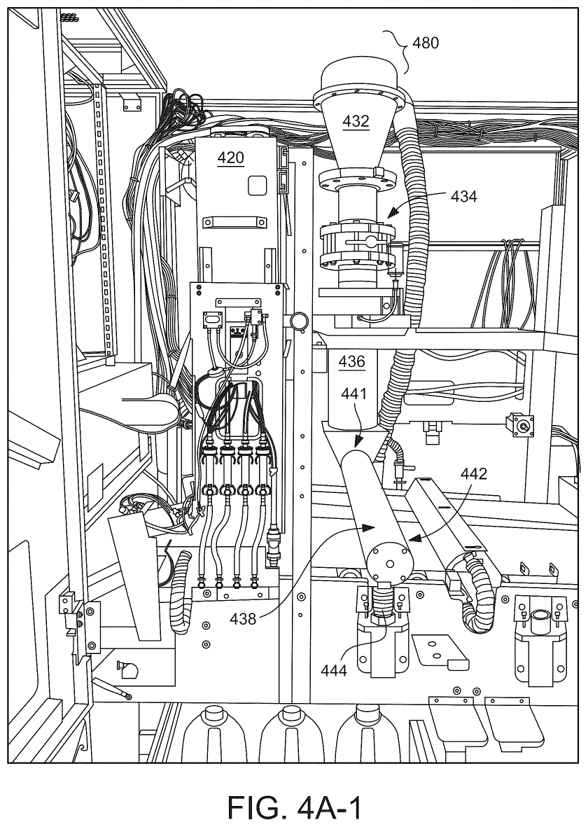

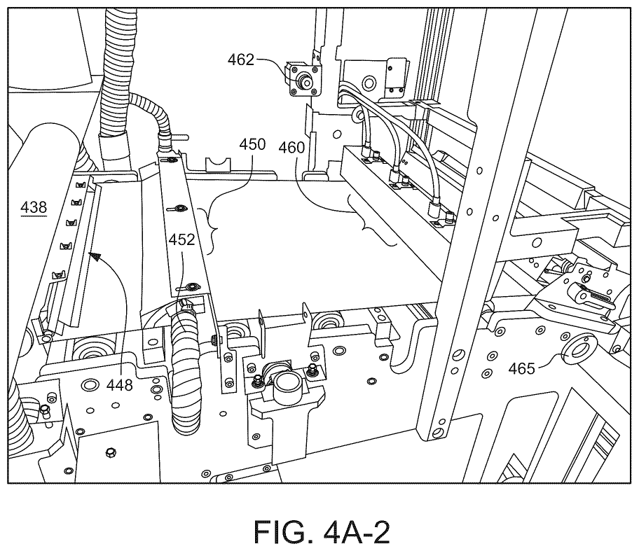

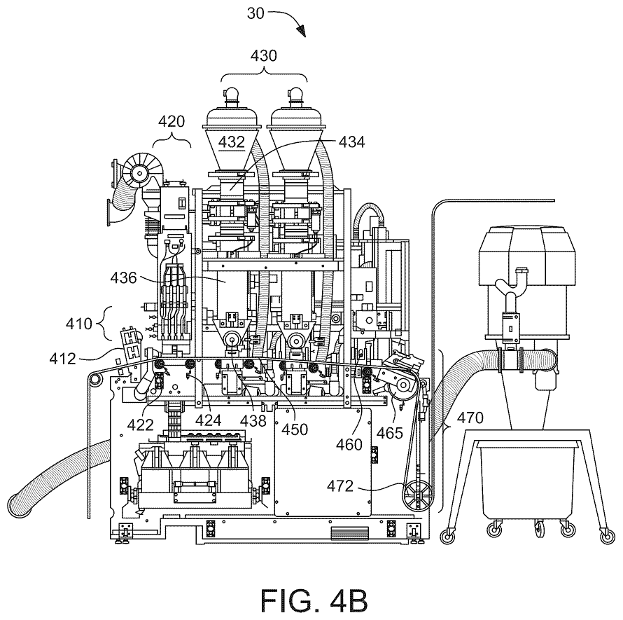

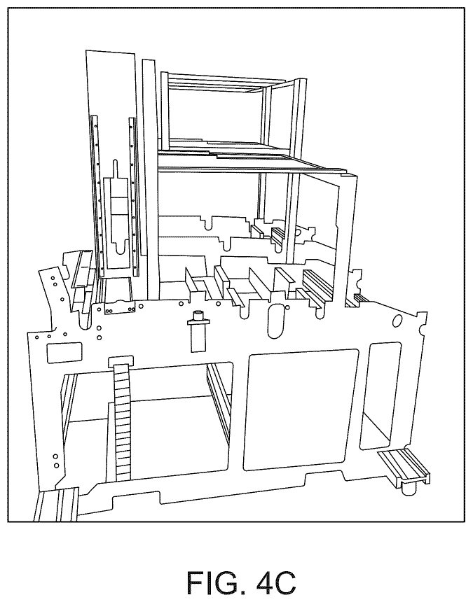

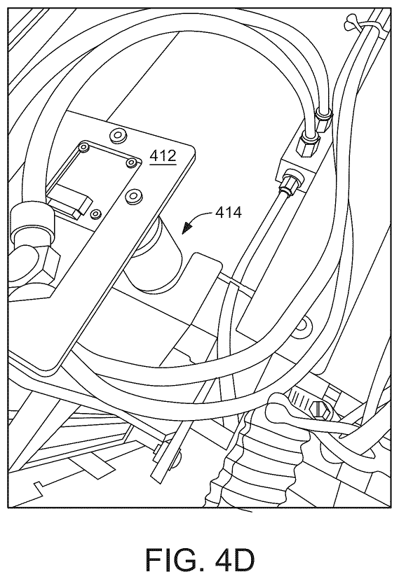

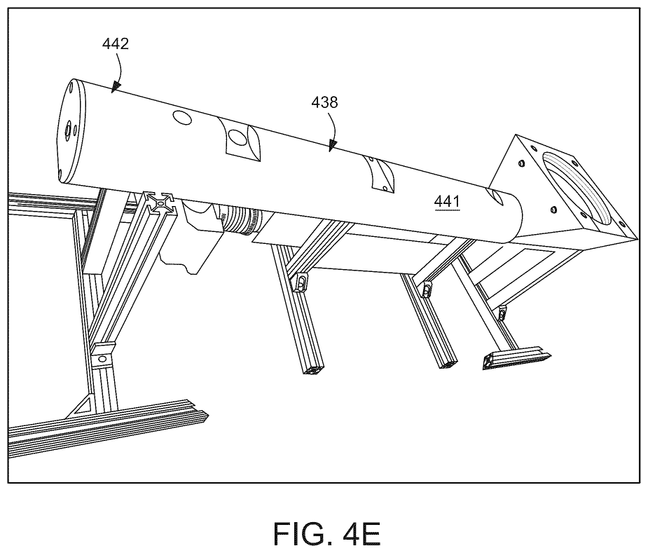

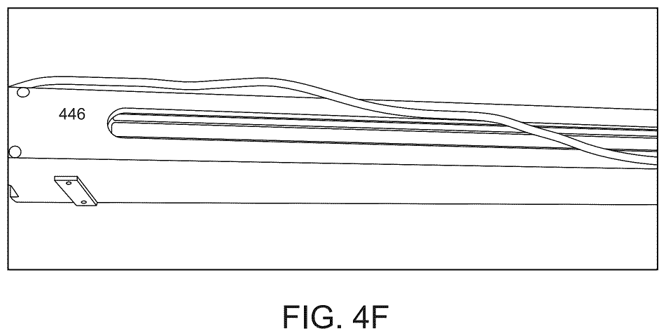

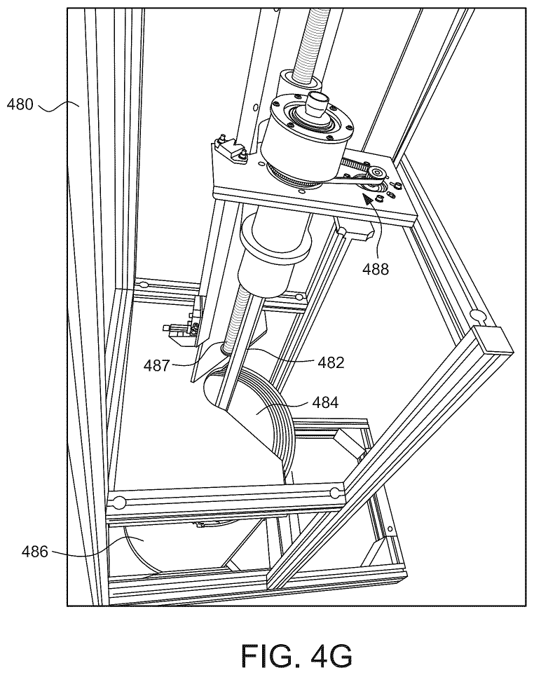

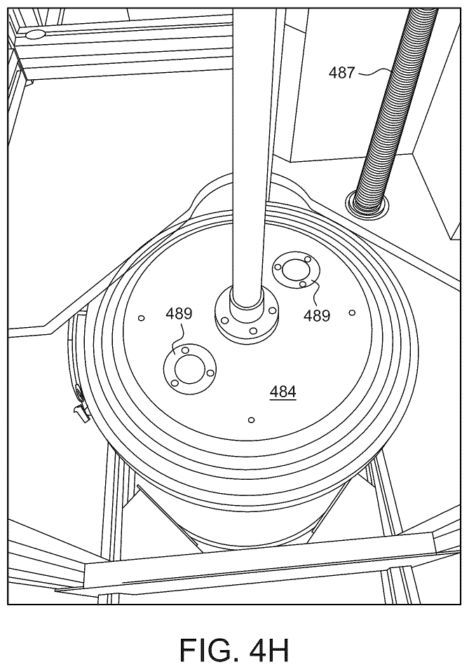

With reference to FIGS. 1, 4A-1, 4A-2, 4B, 4C, 4D, 4E, 4F, 4G and 4H, after leaving velocity sense system 350, substrate material 230 enters the printing, powdering and vacuuming station 30. Substrate material first passes by camera edge sense system 410. Though by this point belt steering system 320 has coarse-adjusted edge positioning of substrate material 230 on the various rollers, some small variations may still exist during processing. Camera edge sense system 410, including camera bracket 412 and camera 414, are configured to cause a digital correction in the subsequent inkjet head printed pattern. It does so by feeding an edge error signal back to the main controller, which then is factored into inboard/outboard image edge placement by those inkjet heads (which the main controller actuates). In effect, the printed image is shifted inboard or outboard to react to any remaining edge deviations and eventually preserve inboard/outboard registration (in like manner to process/cross-process edge registration preserved through processing of the sensed velocity from roller surface encoder 354). Together, the various control systems hereinbefore described permit positioning ink drops to 20-micron tolerances.

Just down-process of camera edge sense system 410, substrate material 230 encounters inkjet head system 420. This may comprise three, or preferably four, or even more, precision inkjet heads, such as W-series inkjet heads made by Xerox, placed over a platen consisting of rollers 422 and 424 that position substrate material 230 just below such heads. Such heads can be arranged generally in a line array, but with slight staggers across the inboard/outboard direction. Small motors exist for each head, in order to facilitate calibrated alignment, such as during a calibration step which prints a test target. After the test target is printed, a scanner camera (to be later described) detects any misalignments and allows for image calibration offsets to be deployed by the master controller, and/or motorized head adjustment. Such staggers and calibration processes are to achieve the goal of having the separate inkjet heads print as if they were one single head. Staggering the heads also advantageously permits overlap in printable regions, so that certain malfunctions or degradations of one print head may be overcome automatically and digitally by engaging an adjacent print head, or by overprinting, as correction or other methods such as dithering which are well known to those skilled in the art.

Meanwhile, as a precision timing tool to assist the later cutting operation, the master controller ensures that an extra mark will be printed in a specific relative location adjacent each image (a “fiducial” mark) in the gutter region of substrate material 230. This fiducial mark on each “sheet” image will get powdered like other inked areas. It will be sufficiently separate from cross-sectional layers of the intended object that a physical instantiation of the fiducial mark will drop off as waste product during final abrasion processing steps.

After a registered image is printed by inkjet head system 420 in an area of substrate material 230 in the ways hereinbefore described, powder system 430 engages to deposit powder (e.g., PEEK) evenly onto the sheet. In implementations, there may be two or more powder systems deployed during any given process run, such that powder system 430 may be doubled, to enable the capability of different powder materials used between or within print runs. Like prior versions of CBAM, powder system 430 relies on a cyclone 432. Below cyclone 432, double dump valve 434 made by assembling two separately controlled valves (each valve made by Posiflate, including a bladder-type valve system) into a serial column separated by a small tube, causes controlled deposition of powder into column 436. In turn, column 436 has a bottom tapered part that acts as a trough and is open below for controlled delivery of powder into a first end 441 of screw transport 438. Screw transport 438 rotates on a motor and moves powder away from column 436 and across toward second end 442, thereby always ensuring that a supply of powder travels across in the inboard direction. Meanwhile, a small length of screw transport 438 at end 442 can be oppositely oriented to move any residual powder away from end 442. An open slot exists on the bottom of screw transport 438, and this slot communicates with vacuum hose 444 near end 442. In this way, waste powder that does not get deposited onto paddlewheel 446 (to be described next) will not build up within screw transport 438 but will be vacuumed away for recycling. Such measures eliminate any need for complex powder waste handling systems, such as counter-screws or returns.

Paddlewheel 446 is also motorized and rotates, rests below screw transport 438, and communicates by way of a top opening slot with the bottom opening slot of screw transport 438. Paddlewheel 446 communicates at its own bottom opening slot with any passing substrate material 230 (via gravity). In operation, paddlewheel 446 has numerous crosswise slots to receive powder evenly across its length when such slots are facing up. Then as it rotates, the slot filled with powder when facing down now dumps a length of powder atop the passing substrate material, essentially all the way across. Immediately downstream, smoothing blade 448 (made of Kapton®) smooths and depresses the “mountain ranges” of powder onto the printed substrate material 230.

After such smoothing, controlled vacuum system 450 engages to remove any powder that has not adhered to printed areas of substrate material 230. It is a controlled vacuum since it is advantageous to provide minimized variation in negative air pressure to ensure consistency of any finished product. Controlled vacuum system 450 operates through hose 452 controlled by a pressure sensor and butterfly valve (not shown) coupled to a real-time controller. It will be noted that from this point forward in the process, no rollers touch the printed/powdered side of substrate material 230, and disks that need to run on the print side touch only the unprinted edge/gutter areas.

After vacuum system 450, scanner camera system 460 engages to serve several purposes. First, this camera effects calibration and inkjet head adjustment during a test run, as hereinbefore described, through interaction with the main controller. Second, during process runs, scanner camera system 460 feeds back imagery of each printed/powdered/vacuumed image as actually visualizable on substrate material 230. The main controller uses such imagery to test for defects in the powdered image, to diagnose the problems, and to perform automated correction where possible. Such automated correction may include overprinting or engagement of compensating adjacent inkjet heads as hereinbefore described. It may also include automated head cleaning of the inkjet heads if overprinting did not fix a previously diagnosed printing/powdering problem. Accompanying such detection and diagnosis, the main controller may separately determine that printed and powdered areas of substrate material 230 must be discarded, with re-printing of the imagery of the to-be-discarded areas. Discard handling occurs at the pre-stacker transport and stacking station, as to be described. Scanner camera system 460 includes motorized brushes (not shown) mounted to motor axis 462 to clean the camera, which runs over the camera before each print run to ensure good image capture.

After scanner camera system 460, powered roller 465 comprises the second powered roller in the system. Thereafter, a second dancer roller/accumulator loop system 470 exists to enable the stop-and-cut process, as to be described next. Disks 472 exist on both the inboard and outboard side of substrate material 230. The inbound-process side of disks 472 still receives substrate material 230 at a near-constant velocity. However, system 470 slides disks 472 and the material they handle up and down in response to the constant stop-start action of the powered roller at the cutting station. Alternatively, the role played by dancer roller/accumulator loop system 470 may be performed by a vacuum process to take up and release slack.

Referring back to cyclone 432 and column 436, despite recycling from various vacuum hoses back into the powder system, there will come a time when fresh powder must be added to the system. This will be accomplished by fresh powder feed system 480. Fresh powder feed system 480 uses shaft 482 to rotate a vacuum nozzle (not shown) under a powder container lid 484 inside a powder container 486. Lead screw 487 ensures slow descent of the nozzle into the powder container 486 as powder is consumed. Hence, the vacuum nozzle moves downward in container 486 in a spiral manner, thus capturing all the fresh supply in such container without waste. Belt and gearing 488 accomplish the necessary rotation, under ultimate control of the main controller. A level sensor coupled to column 436 indicates to the main controller a level of powder in the system, thus allowing it to determine whether to actuate (or de-actuate) fresh power feed system 480. When actuation occurs, lid 484 contains air inlets 489 to ensure proper circulation.

### 4. Cutting Station

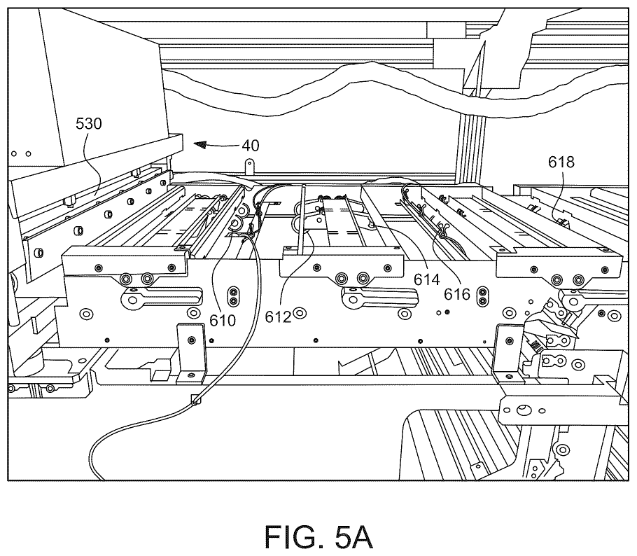

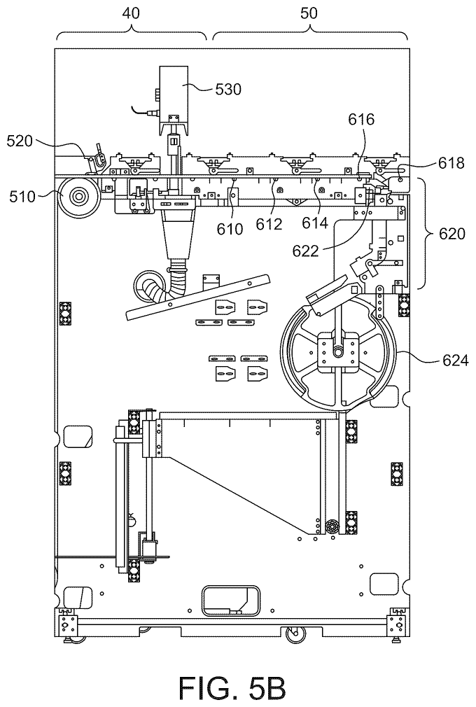

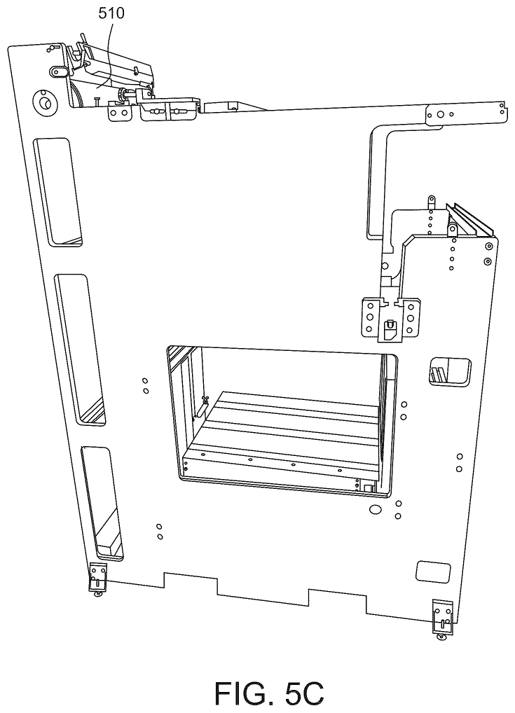

With reference to FIGS. 1, 5A, 5B and 5C, cutting station 40 begins with powered roller 510 stopping and starting just after dancer roller/accumulator loop system 470. Here, sensor 520 signals to its associated real-time controller when a fiducial mark on a traveling web of substrate material 230 has reached the sensor location. Sensor 520 has been physically calibrated to a precise location adjacent and upstream of the pneumatic cutter 530. The sensing of the fiducial mark causes powered roller 510 to stop, then pneumatic cutter 530 to start, such that a precisely registered edge cut gets made straight and evenly across the inboard/outboard direction of substrate material 230. Once the cut is finished, powered roller 510 re-starts, with the outcome that its average speed (counting both times when started and stopped) equals the average speed of the substrate material 230 traveling through the previous stations of machine 100. In this way, the web roll is accurately cut into sheets, maintaining all subsequent registrations achieved by upstream means.

As discussed, the fiducial mark is preferred for establishing timing of the cutter operation. However other alternatives known in the art are possible and contemplated, including a surface encoder.

Unlike rollers elsewhere in the system, roller 510 is a precision roller with closed loop servo control. It is preferably a custom-made precision roller with total indicated runout (TIR) of less than two one thousandths of an inch. It has been discovered that for optimum registration performance, this roller must have such precision, even though such precision is not needed in other rollers of the system.

### 5. Pre-Stacker Transport and Stacking Station

With reference to FIGS. 1, 5A, 5B, 6A, 6B, 6C, 6D, 6E, 6F, 6G, 6H, 6I, 6J, 6K, 6L, 6M, and 7A, the pre-stacker transport and stacking station 50 begins just after cutting, where subsequent powered rollers 610, 612, 614, 616 and 618 drive cut sheets further down-process (each with companion idler rollers touching the top of sheets only at the gutter regions). If the main controller had flagged a particular printed substrate material 230 area as defective (e.g., via the scanner camera system 460 and its interoperation with the main controller), the main controller engages discard system 620 to actuate for as many sheets as necessary until a non-defective re-print sheet is allowed to pass to downstream stations. Discard system 620 includes solenoid-operated trap door 622 that automatically opens under control of the main controller to “swallow” a passing sheet, then deliver it to discard stacker disks 624 (which operate on a similar principle as regular stacker disks, to be described next). Discard stacker disks 624 permit orderly disposal and later retrieval of waste sheets from a dedicated bin.

If a sheet has not been flagged as containing a defect, it proceeds normally. In this case, powered bottom-roller movement continues to cause the leading edge of a sheet to reach stacker disks 630, 631. In the present implementation, four stacker disks are used (though two or three are possible), aligned in a row. Each outer stacker disk 630 contains flat chord 632 just ahead of slot and channel 634 to allow controlled entry of a sheet, while each inner stacker disk 631 has flat chord 632 but lacks a slot and channel. Outer stacker disks 630 contain flexible fingers 633 to aid in sheet weighting and travel into slot and channel 634. That is, as a disk rotates, gravity and spring biasing cause each long flat finger to “flop” such that it touches and weighs down each sheet along its edge just at the moment the sheet has deposited onto jig surface 643 (or a stack resting on jig surface 643). Such fingers then slide off and rotate away as the sheet's leading edge collides with the back of slotted surface 642. At the time of sheet-entry, stacker discs 630 are stationary until the moment when the trailing edge of a sheet has passed an edge sensor, just downstream of the final powered roller 618. Once the edge sensor detects trailing edge sheet passage, main controller actuates stacker sheet to roll, loaded with a sheet, 180° to deposit such sheet onto an existing stack, which will be disposed on elevator system 640, and then stop. A second, identical, flat chord 632′ with slot and channel arrangement exists 180° apart on stacker disks 630, as well as the same chord on stacker disks 631, so that once stopped after a deposit, disks are configured to reload immediately.

Elevator system 640 interacts with stacker disks 630, 631 so that a slotted surface 642 serves as a backing to push an edge of a loaded sheet to eject such sheet off stacker disks 630 once such disks are fully rotated 180°, and onto jig surface 643 (or a stack resting on jig surface 643), as those disks rotate just before they stop. The slots in slotted surface 642 are configured for the disks to pass through and rotate unimpeded. Elevator system 640 descends jig surface 643 on vertical servo-controlled lead screw 644 in a controlled fashion as sheets stack up, based on a signal from a level sensor. This permits stacker disks 630, 631 to remain stationary in height throughout their spinning processes, always to be available (upon stopping) to receive a next sheet.

The Applicant discovered that if slot and channel 634 of stacker disks 630 were simply parallel to the horizontal during use (or more precisely, parallel to the transverse edge of a disk), a significant amount of bowing would occur at a sheet's leading edge, particularly in larger sheets that are 20 inches square. Such bowing would cause undesired friction just as stacker disks eject a new sheet onto a stack through a sheet edge hitting of the backing of slotted surface 642, risking mistaken deposit of sheets, and ruining previously preserved registration. A solution to the bowing problem involves implementing a circumferentially variable angle for the slot and channel 634. Namely, at the entry point the angle is parallel to the ground and to the disk's transverse edge, yet as the leading edges of the sheet proceed into slot and channel 634, that slot angle changes slightly to counteract the bowing, slightly tensioning the leading edge to prevent the same. This involves angles at the innermost part of slot and channel 634 slightly toeing clockwise (with respect to the downstream direction) on the right side, and counterclockwise on the left side, about 2°-7°.

To aid in edge registration, station 50 includes tampers positioned at a 90° angle with respect to one another. These engage via solenoid actuation once a new sheet has been deposited to a stack to gently tamp both the trailing edge of the sheet (which now is “in front” due to the stacker disk roll) with one tamper 652, and the side edge with the other tamper 654. The resulting stack is corner-registered.

Since each tamper must have unimpeded contact with a sheet edge to function, the surface on which the sheet stack rests must have corresponding mated notches. Thus, the edge of that surface is not a straight line but has a notch in it at the location where the tampers would press a sheet stack. These notches are needed for tamping of about the first 100 sheets. Once the surface drops far enough (after the first 100 or so sheets), the presence of the notch no longer matters since the tampers touch the sheet edges unimpeded anyway.

Station 50 also includes a downward-pointing image camera 662. This serves as a final quality review camera, interoperating with the main controller to alert an operator to jams or image integrity problems (e.g., the topmost sheet in the stack lacks the expected image).

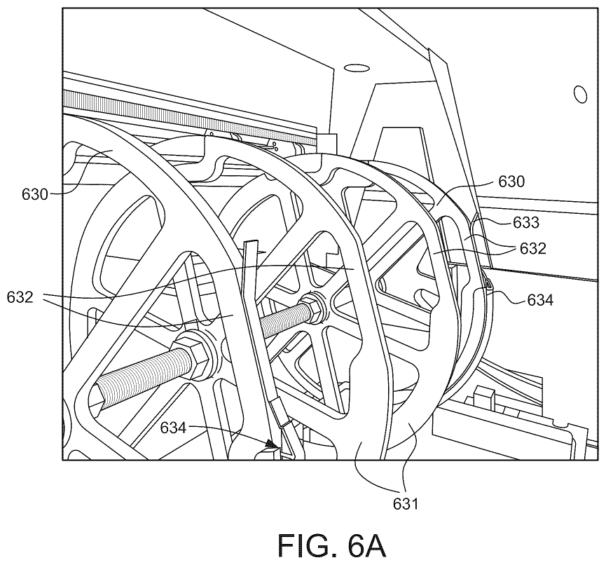

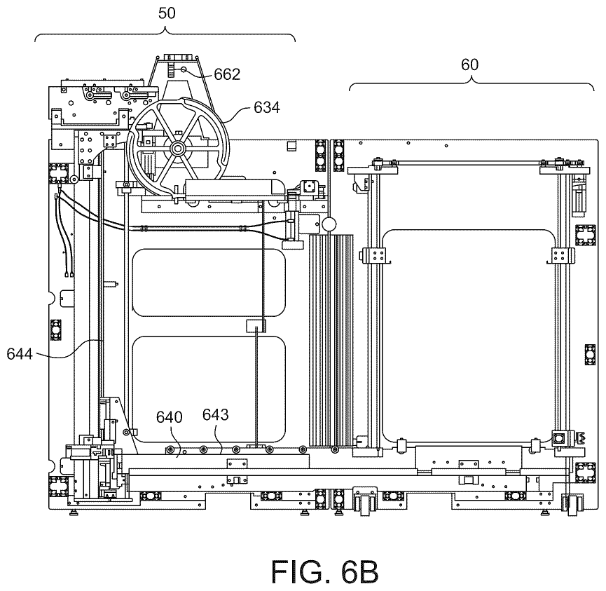

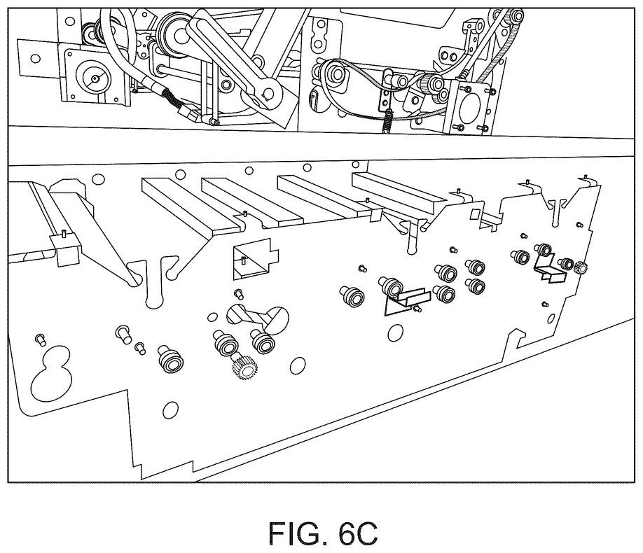

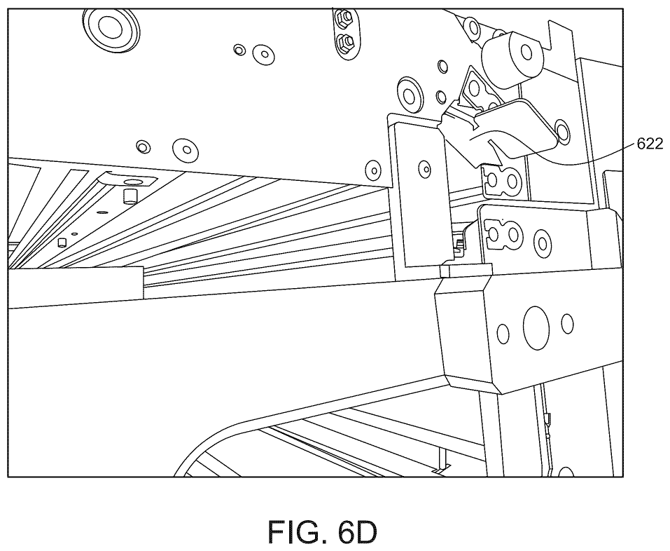

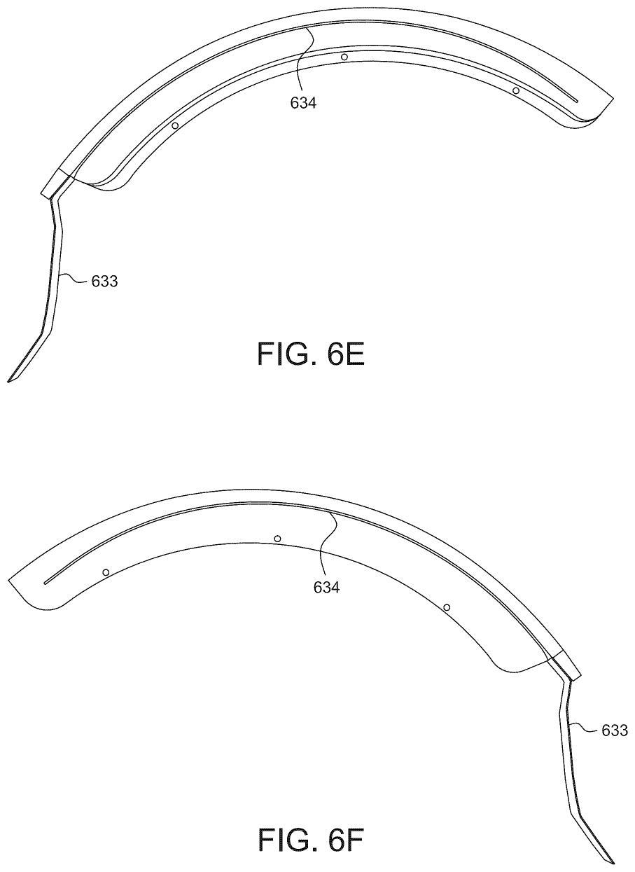

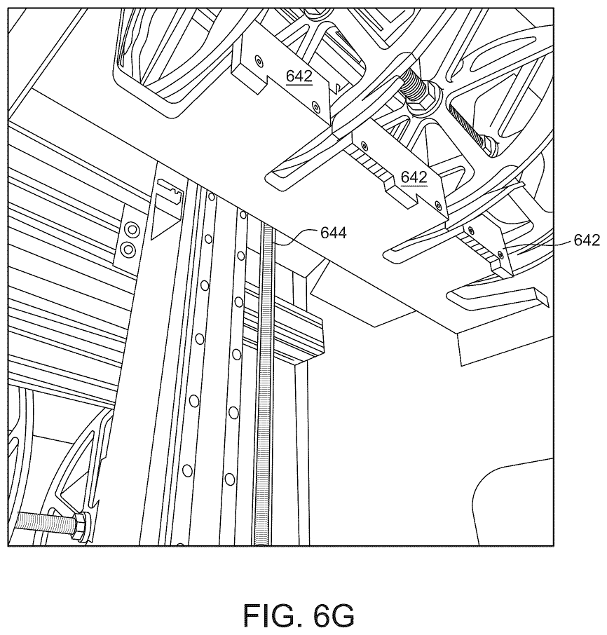

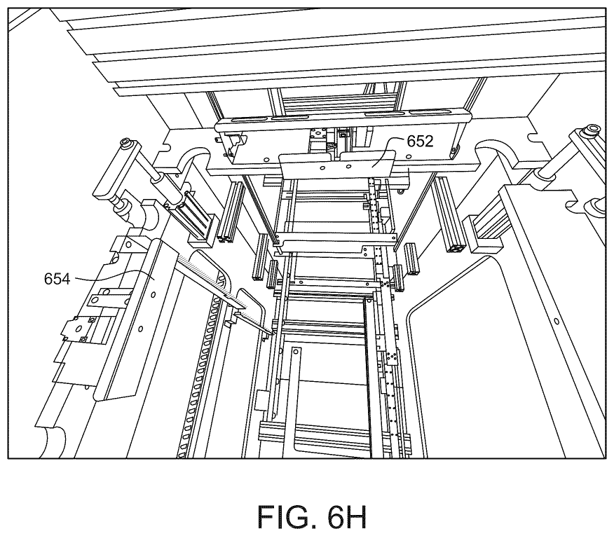

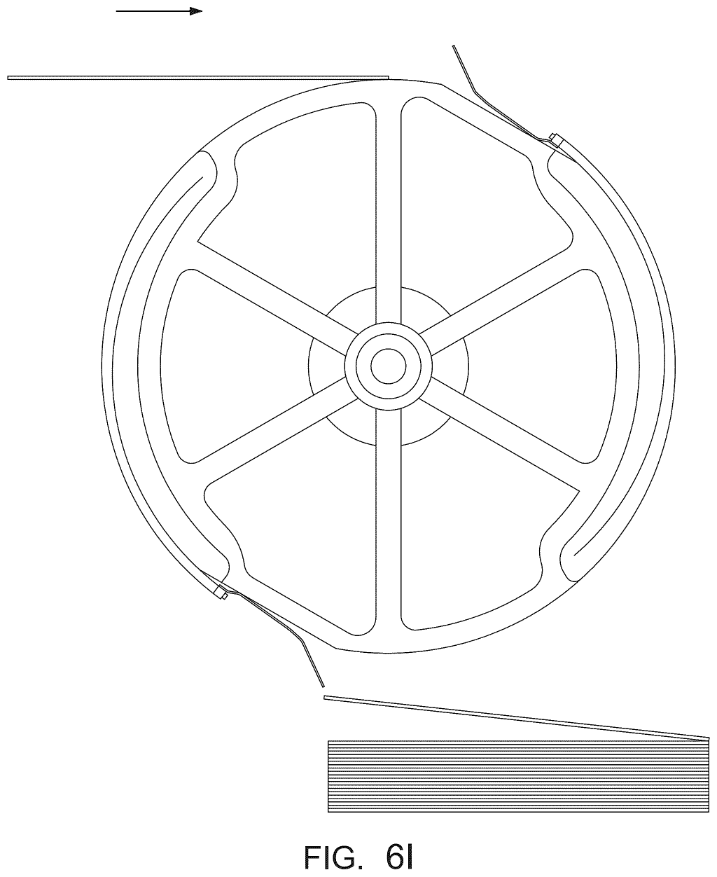

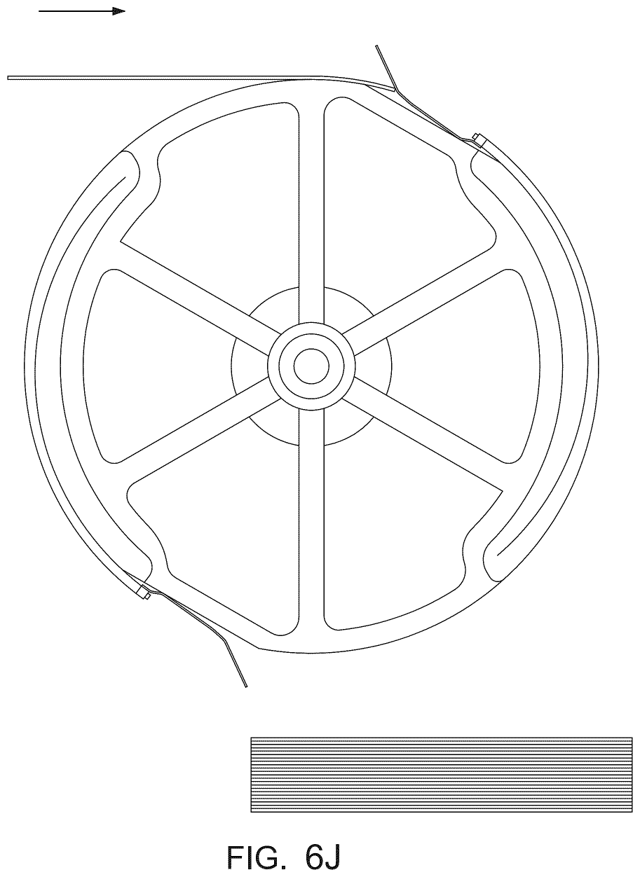

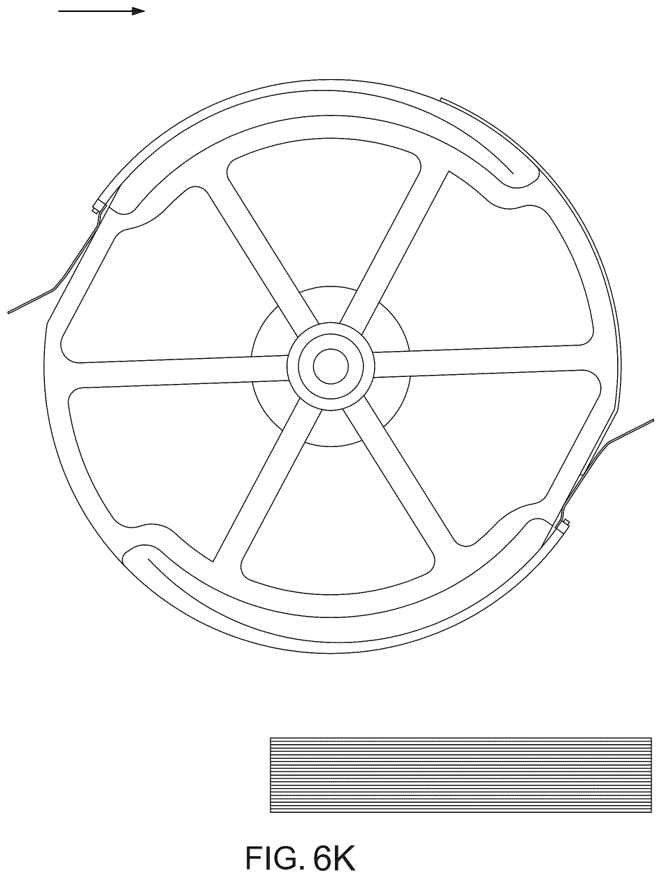

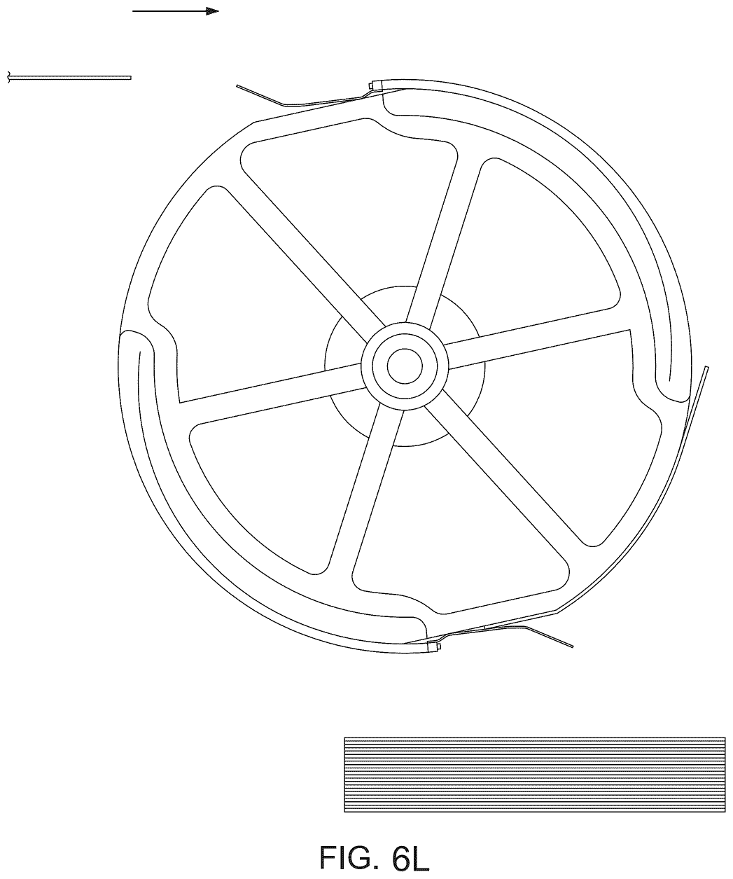

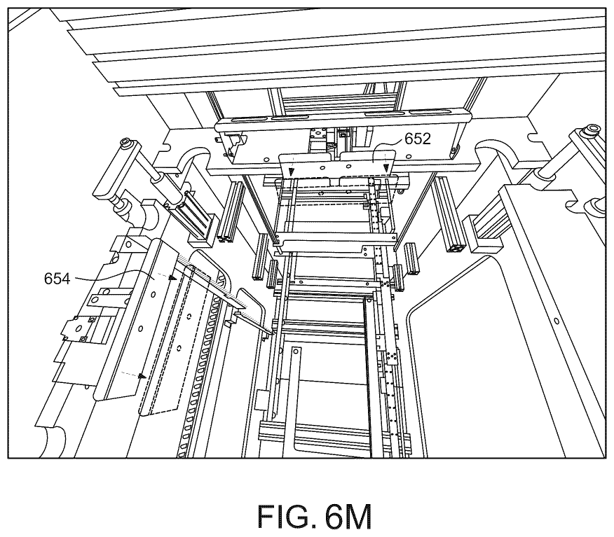

FIG. 6I shows a printed sheet being delivered to the stacker, with the sheet contacting the perimeter of the stacker disks 630, 631, while another sheet drops from the disks 630, 631 onto a stack of sheets. The distance between the disks 630, 631 and the stack are exaggerated for clarity. FIG. 6J shows the sheet advancing further into the stacker, where the leading edge of the sheet is guided into the slot and channel 634 of the outer disks 630. The leading edge of the sheet drops into slots on the perimeters of the two inner stacker disks 631. As the stacker disks 630, 631 concurrently rotate, they carry the sheets toward the stack, as shown in FIGS. 6K and 6L, drawing the slots and channels away from the sheet and depositing the sheet onto the stack. As shown in FIG. 6M, tampers 652, 654 positioned at the side and end of the stack tap the edges of the stacked sheet to ensure precise registration. Movement of the tampers 652, 654 is exaggerated for clarity.

### 6. Press Jig Assembly Station

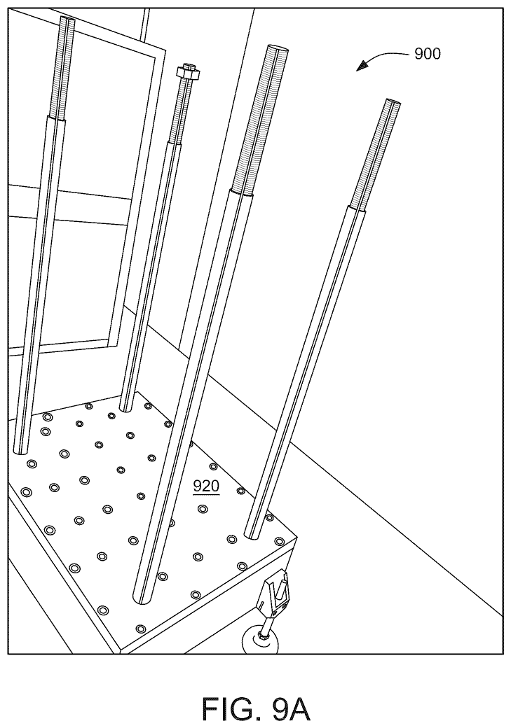

With reference to FIGS. 1, 6B, 7A, 7B, 7C, 7D, 7E, 7F, 7G, 7H, 7I, 7J, and 8, the press jig assembly station 60 begins just after stacking. In particular, after a print run is finished and all sheets have been deposited with image-to-edge registration as hereinbefore described, and with edge-to-edge and corner-registration as hereinbefore described, press jig surface 643 with its finished stack will descend to the bottom of station 50, then move under automatic control to station 60. This station-to-station movement occurs through operation of servo-controlled horizontal lead screw 710 moving the entire loaded jig surface 643 one station away. Once the loaded jig surface 643 reaches the press jig assembly station 60, another servo controlled lead screw set 712 permits lid 714, which has been resting this entire time on brackets 716, to descend onto the topmost sheet of the stack to prepare it for undisturbed transport. In this regard, forked cart 810 is sized to permit lifting of the lidded, stack-containing press jig. Forked cart 810 is powered, since the press jig is likely heavier than a single person can lift unassisted.

It will be appreciated that the weight itself of sheets as they stack on top of one another causes some degree of entanglement of fibers which are not completely horizontal (primarily in the vertical direction). This contributes to immobility of adjacent sheets with respect to one another. This immobility helps preserve the registration that has already been achieved. When the press lid compresses the stack, its weight causes further entanglement and immobilization (more fibers are entangled, and fibers go deeper into adjacent sheets).

A reverse process serves to configure station 60 for a new print run. Namely, brackets 716 rest near the ground when station 60 is in an unloaded configuration. At that point, an empty jig surface lid 714 can be loaded into station 60 by placement (preferably with the powered forked cart 810) onto such brackets. Servo controlled lead screw 712 now lifts lid 714 via such brackets to store it away until it is needed later at the end of a process run. Meanwhile, empty jig surface 643 can likewise be placed inside station 60, where horizontal servo controlled lead screw 710 will move it upstream back to station 50, and vertical servo controlled lead screw 644 will elevate it to sufficient height to be ready to receive a first sheet of a stack of a new process run.

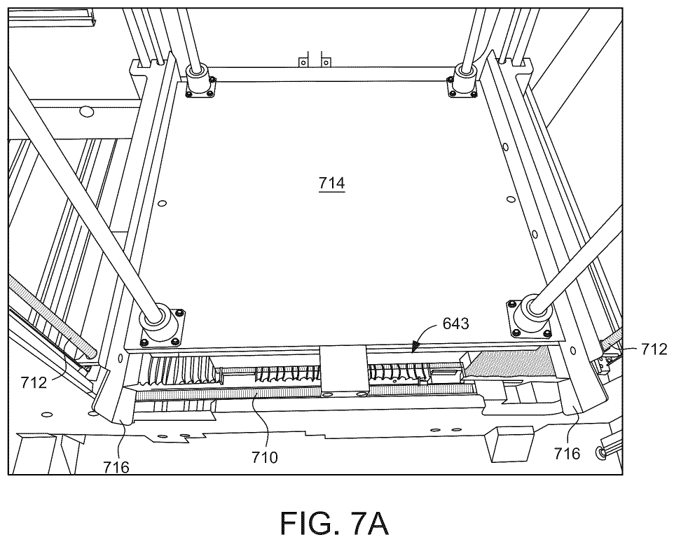

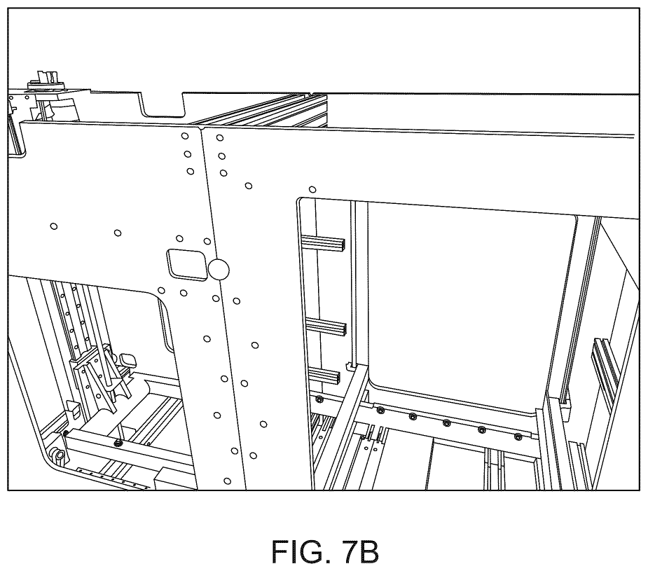

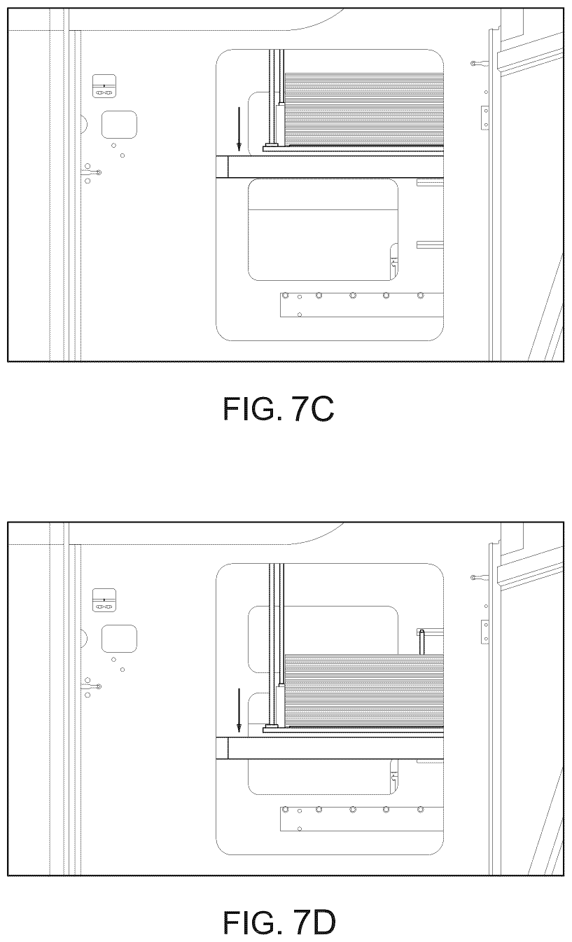

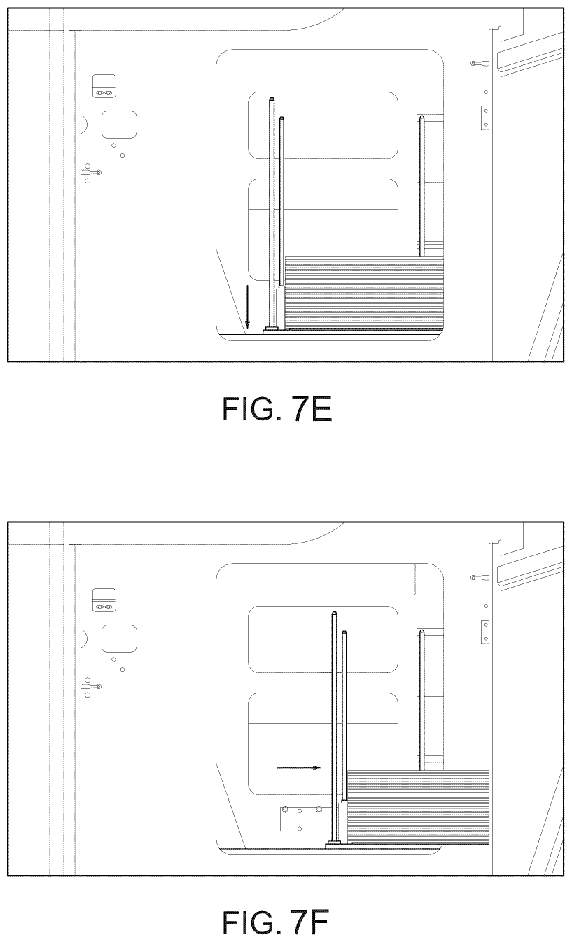

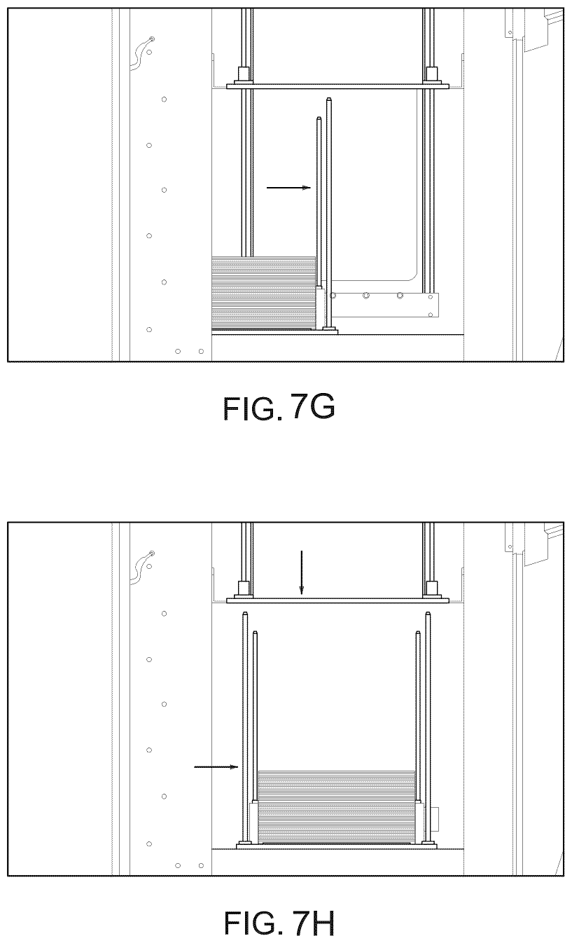

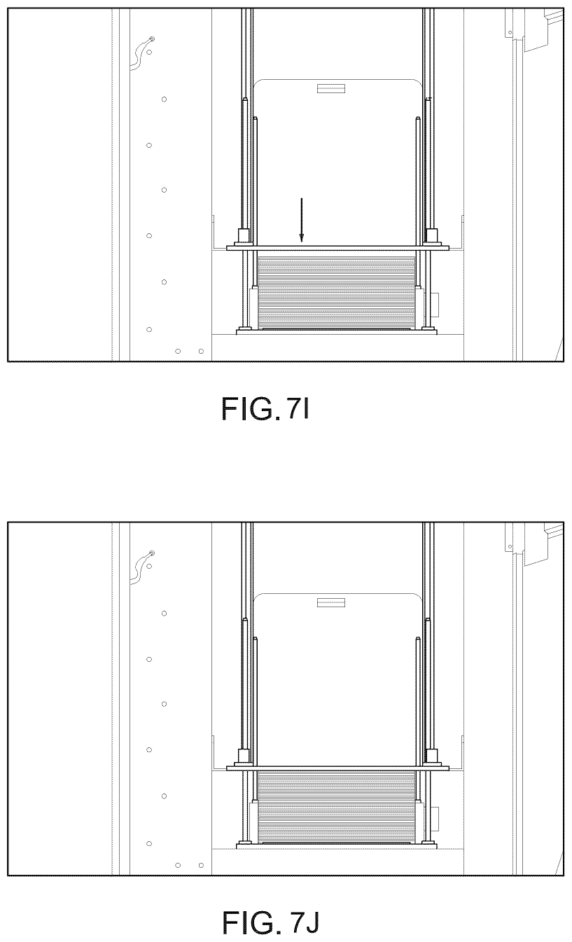

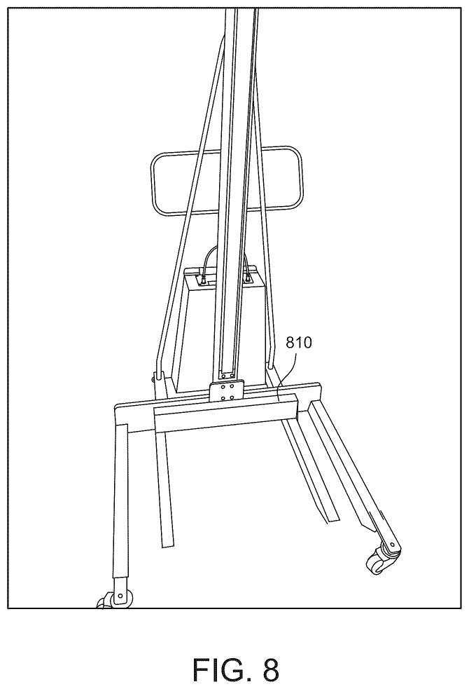

FIGS. 7C, 7D, and 7E illustrate the vertical descent of a completed stack within the press jig assembly station. The stack, positioned on a jig surface 643 supported by an elevator system 640 with a servo-controlled vertical lead screw 644, is lowered in a controlled manner to maintain precise alignment of the stacked sheets. FIGS. 7F, 7G, and 7H show the subsequent horizontal movement of the stack as it is transferred from the stacking station to the press jig assembly station. The stack is advanced horizontally by a servo-controlled lead screw, ensuring smooth and accurate positioning for the next stage of processing. Throughout these steps, the structural components of the press jig assembly station, including brackets 716 for supporting the lid 714, guide and stabilize the stack during both vertical and horizontal movement. This coordinated sequence preserves the edge-to-edge and corner registration of the sheets, preparing the stack for the assembly of the jig and subsequent pressing operations.

Once the horizontal movement of the stack is complete, the jig lid 714 is lowered onto vertical shafts extending from the jig surface 643 until it rests on the stack, as depicted in FIGS. 7H, 7I, and 7J. The stack of registered sheets is now securely immobilized in preparation for removal from the press jig assembly station and subsequent pressing and fusing operations. This configuration ensures the stack remains precisely aligned and undisturbed during transport and further processing.

### 7. Press Station

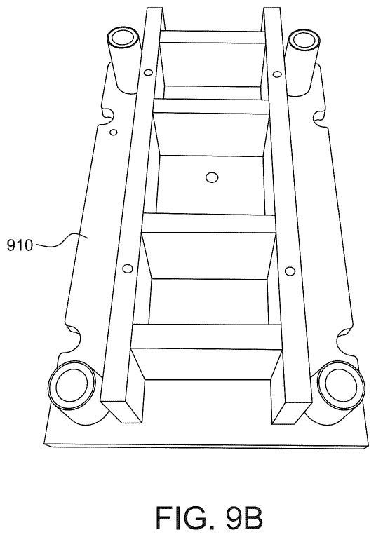

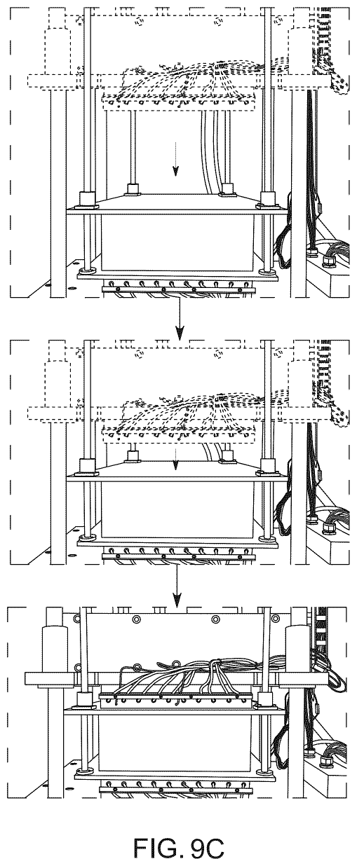

With reference to FIGS. 9A, 9B, and 9C, press station 900 includes a press top 910 and a press bottom 920. In operation, as depicted in FIG. 9C, a loaded, lidded press jig assembly is placed inside on the press bottom 920, the top 910 is lowered onto the jig lid 714, and pressing commences.

### 8. Oven Station

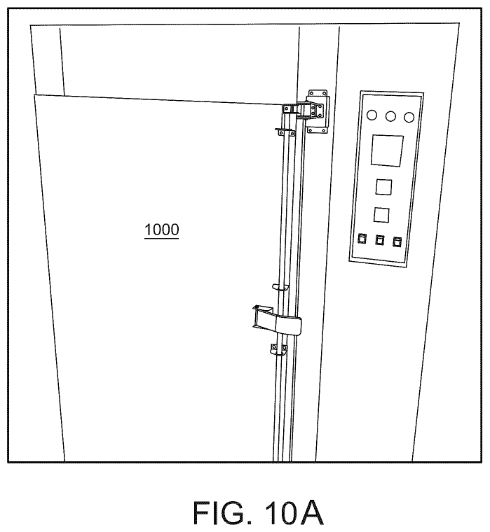

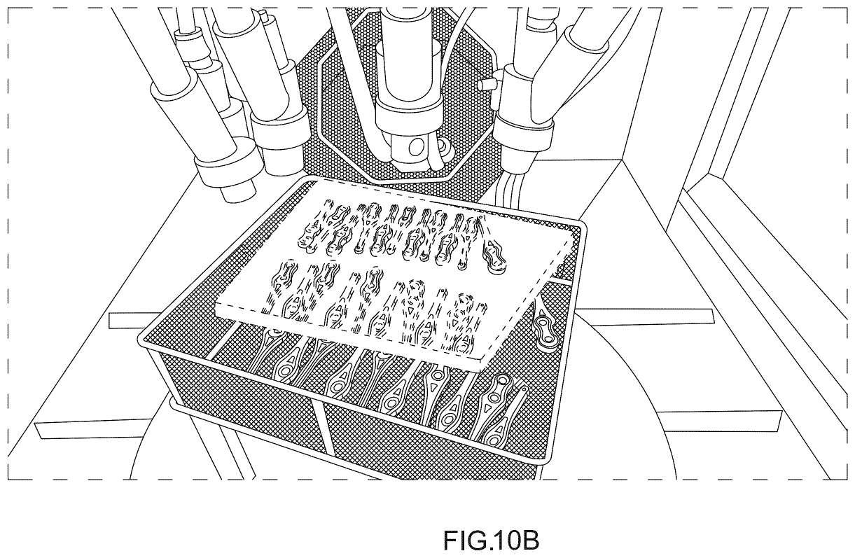

With reference to FIG. 10A, oven 1000 is sized to receive press station 900. As with conventional CBAM, temperatures are selected that will permit flow of melted powder material between adjacent layers of the powdered substrate material.

Before now, the conventional way to allow such parts to cool to yield a build block that can be passed to the next station was to maintain the Z-dimension of the press during cooling. However, Applicant discovered that in some situations, differential cooling of the part (i.e., caused by different crystallization rates and coefficients of thermal expansion) leads to stresses and strains during cooling, potentially weakening and possibly causing shrinkage and warpage which has an effect on the dimensional accuracy of the final part. As a polymer cools, it goes through several transitions from liquid to solid, and as a solid, the degree of crystallinity changes as cooling occurs as well. Parts typically contract or shrink as they cool. Thus for example, some thermoplastic material might exist in a glass transition state while other parts are in a solid state when cooling and shrinking occurs.

Applicant has discovered an improved technique for maintaining structural integrity during cooling. This technique minimizes part distortions and improves tolerances. Namely, a press lid will press to a theoretical Z-position based on the number of sheets that make up the build block before cooling is to begin, and when the polymer is liquid. As the transition to solid occurs, and the part cools, the vertical press position will be controlled to “follow” the Z-dimension down as the part cools and shrinks. The appropriate final position (and hence, speed) can be determined by the temperature, or by an alternative method determined by experiment and/or simulation.

### 9. Substrate Removal Station

It will be appreciated that the substrate removal station will be any suitable location (such as a sandblasting cabinet) where cooled build blocks may be manipulated to remove non-printed and non-powdered areas, which all should remain friable relative to intended areas of the 3D object that now contains the hardened flow composite. It will be noted that the waste product result of the fiducial mark (described before in the context of a mark-signal for edge cutting) will also fall away in this stage. Alternatively, dry ice blasting may serve the same purpose as sandblasting. In some applications, a dissolving solution may alternatively be used or be used in combination with such abrasion/blasting techniques. As described in previous patents chemical means of removal may also be used.

An exemplary substrate removal station having a plurality of nozzles is illustrated in FIG. 10B. A build block is shown in phantom, illustrating the completed 3D objects present within the friable substrate. Parts freed from the substrate are shown in the basket beneath the build block.

### Logic and Control System Management

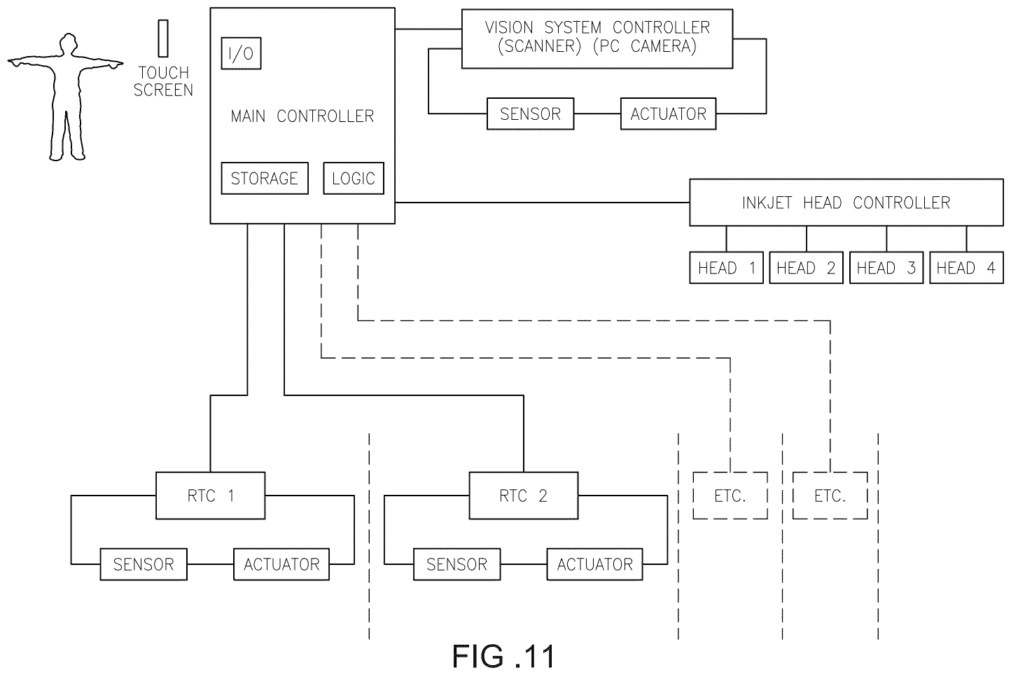

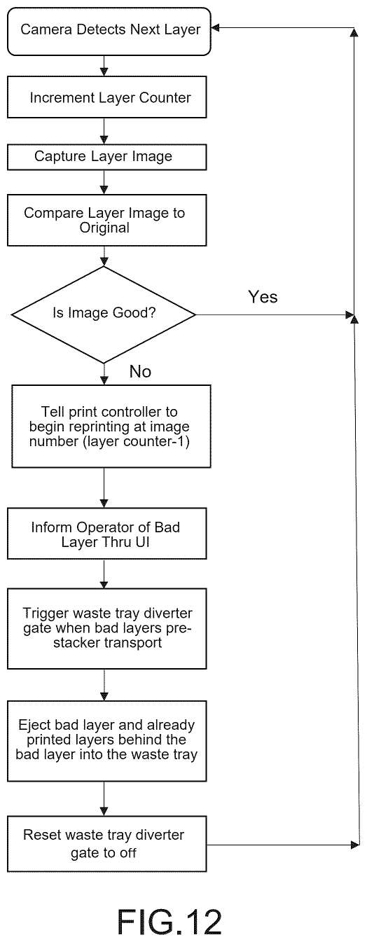

With reference to FIGS. 11 and 12, and as apparent from the foregoing description, machine 100 is controlled via a main controller, subsidiary realtime controllers and an additional vision system controller. In general, the main controller drives the user interface, including touchscreen actuation for start and stop, and to visualize various alarms and system statuses and provides the general coordination and timing control for the machine and configures and manages the realtime controllers. The main controller also directly communicates with and downloads the desired printing patterns for each layer to the inkjet head controller boards which directly drive the inkjet head actuators. The desired image pattern for each printed layer is generated and prepared by an offline computer using slicing software which generates the layer pattern for each printed layer from standard 3D CAD files. The main controller buffers and stores the layer patterns for each job and downloads them to the inkjet head controllers as needed. The vision system controller does image capture and image processing of the scanner camera 460 and quality control camera 662. In addition, the main controller communicates with the subsidiary real-time controller responsible for aforementioned trap door 622 at appropriate times when image faults occur and coordinates the reprinting necessary to replace any faulty layers in the final build. The main controller also keeps track of setpoints for various desired system parameters. However, machine 100 requires real-time control for many of its constantly moving parts. In this case, main controller will supply the necessary setpoints to respective real-time controllers but will rely on the real-time controllers to perform the communication with sensors, calculation of error signals, and actuation signals to make adjustments.

In general, the following processes exist in the main controllers:
(a) Overall system coordination, timing, sequencing and control.
(b) Managing the image files for printing each layer.
(c) Communicating with and downloading the necessary programming and data to all the real-time subsidiary controllers and the inkjet head controllers, as well as receiving and monitoring status information and error message from those controllers.
(d) Interacting with and responding to the user through a user interface to, for example, allow the user to determine which parts are printed in what sequence, to help the user monitor system status and assist the user as necessary when user interactions such as loading new printer material supplies are needed or removing completed part builds from the system as well as diagnostic functions.
(e) Communicating with and responding to information from the vision system controller.

In general, the real-time controllers interoperate with the main controller, and interoperate with their indicated systems in variety of ways including:
a) Motion control of a variety of motors of various types (e.g. both servo and stepper motors).
b) Triggering and timing for a variety of other actuators such as web cutter 520, double dump valve 434 all others described above in the context of real-time control.
c) Monitoring a number of sensors to measure a variety of physical conditions such as pneumatic pressures, valve position, physical positions as well as the presence and amount of a variety of materials such as ink, powder and substrate and many others including but not limited to information from the vision system.
d) Utilizing the signals from the sensors, combined with various on/off, continuous and discrete control strategies to maintain desired the desired state of multiple physical conditions in the system. Such conditions include substrate velocity and position, powder deposition amounts, air-flows as well as many others.

Main controller and computer vision equipment generally comprises a high-performance general purpose multi-core computer provided by suppliers such as Supermicro with associated multi-channel high speed data transfer ports for image transfer.

Realtime controller equipment generally comprises high-performance real-time controllers with multiple analog and digital I/O's such as those from the Agito Akribis Central-I series.

Table 1, below, lists controllers utilized in the apparatus of the present disclosure, including what is controlled and what setpoints are delivered from the main controller.

TABLE 1
Major System Controllers

| | | Control approach, inputs and |
|---|---|---|
| Controller | Function | outputs |
| Unwinder | The unwinder controller | It achieves this function by |
| | controls the surface | continuously monitoring the |
| | velocity of the substrate | diameter of the roll of substrate and |
| | fed into the printing | then using that information to control |
| | module. | the angular speed of the unwinder |
| | | motor to feed the web of substrate |
| | | into the system at the desired |
| | | surface velocity. The angular speed |
| | | of the unwinder motor is measured |
| | | through a motor encoder which is |
| | | the input into a closed loop controller |
| | | which determines motor supply |
| | | current to maintain the desired |
| | | angular velocity. |
| Lateral Web | The web of substrate | The lateral web position is sensed |
| Positioning | material is positioned | through two sensors which are |
| | laterally (i.e. the | continuously monitoring the position |
| | direction perpendicular | of the edges of the web. These |
| | to the web transport | position measurements are used to |
| | direction in the plane of | control the positioning of a web |
| | the web) so that the | steering roll whose position changes |
| | inkjet image is printed | to drive the web in the desired lateral |
| | in the right location | direction to maintain the desired |
| | laterally on the web. | web lateral position. |
| Web Tension and | Both the tension of the | There are two motors connected to |
| Velocity in | substrate web and the | two driven rolls - one prior to the |
| Printing Zone | velocity of the web are | printing zone and one immediately |
| | controlled for uniform | after the printing zone. Each motor |
| | printing. | has an angular encoder and there is |
| | | a web tension sensor system as |
| | | well. The angular velocities of each |
| | | motor are controlled through their |
| | | input currents independently such |
| | | that both the web substrate surface |
| | | velocity and the web tension are |
| | | controlled. |
| Powder Feed and | The Powder deposition | The Powder deposition sub-system |
| Transport | sub-system must be | has a powder supply buffer which |
| | supplied with powder to | must be filled. That powder buffer |
| | deposit on the web. | has a sensor which continuously |
| | | monitors the amount of powder in |
| | | the buffer and when a low threshold |
| | | level is sensed triggers a powder |
| | | feed system to feed powder from a |
| | | supply barrel. The powder is fed |
| | | using vacuum to the powder |
| | | deposition system and when the |
| | | powder level in the powder buffer |
| | | hits a high threshold level the |
| | | powder feed system is turned off. |
| Printing | The desired pattern of | A printhead controller is informed by |
| | powder for each layer | the system which image to print for |
| | is determined by | the desired layer and a nominal |
| | applying that pattern in | firing frequency and a desired |
| | a printed fluid applied | nominal lateral position are both set |
| | through inkjet heads | which would result in the printed |
| | arrayed across the | image on the substrate replicating |
| | web. | the desired image at the nominal |
| | | web velocity and lateral position. |
| | | However, due to normal |
| | | disturbances, there are small |
| | | variations in both web lateral |
| | | position and velocity. To further |
| | | perfect the image and to faithfully |
| | | reproduce the desired pattern on the |
| | | substrate additional control loops |
| | | are applied. One control loop uses |
| | | a surface encoder to measure the |
| | | surface velocity of the substrate, |
| | | and the firing frequency of the inkjet |
| | | heads is adjusted from its nominal |
| | | value to correct any resulting |
| | | positional errors in the direction of |
| | | the web transport. Another control |
| | | loop uses a computer vision system |
| | | to measure the actual lateral |
| | | location of the web and calculates |
| | | the error in web lateral position from |
| | | the nominal and digitally shifts the |
| | | image laterally so that the |
| | | appropriate inkjet head nozzles are |
| | | fired to correct for the lateral position |
| | | error. Together these control loops |
| | | result in a more faithful positional |
| | | location of the desired image on the |
| | | web substrate. |
| Powder | Powder is transported | Powder is transported laterally |
| Deposition | from the powder supply | across the web from the powder |
| | buffer and deposited | supply buffer using a screw |
| | across the web at a | transport. The screw transport |
| | desired flow rate. | velocity is controlled to deliver the |
| | | desired volume of powder through a |
| | | motor with an encoder with the |
| | | motor current being the major output |
| | | and encoder position as input. As |
| | | the powder is transported laterally |
| | | through the auger motion, powder |
| | | falls from the auger body through a |
| | | small slot at the bottom of the auger |
| | | body into a rotating powder wheel |
| | | assembly. The rotational speed of |
| | | the powder wheel assembly |
| | | determines the mass of powder |
| | | deposited on the web and that |
| | | speed is controlled through the |
| | | motor input current as the output |
| | | and motor encoder as the input. |
| | | Finally, the powder wheel deposits |
| | | the material non-uniformly as small |
| | | “Mountain ranges” onto the web. A |
| | | smoothing blade is used to level out |
| | | the powder on the web. The height |
| | | of the blade position above the |
| | | substrate surface is controlled to |
| | | make that process repeatable and |
| | | controllable over time and with |
| | | different powders. The height of the |
| | | smoothing blade is controlled |
| | | through two stepper motors |
| | | attached to each end of the blade |
| | | and each motor has an encoder and |
| | | the motor position is set to the |
| | | desired angular location that |
| | | corresponds to the desired blade |
| | | height by measuring the motor |
| | | encoder position and controlling the |
| | | applied current to the motor. |
| Excess Powder | Powder is distributed | Maintaining relatively constant |
| Removal/Vacuum | across the entire | vacuum pressure helps to maintain |
| | substrate but will stick | uniform powder deposition in the |
| | only to the areas | inked area and to ensure that all the |
| | printed with ink by the | powder is vacuumed up in the non- |
| | inkjet heads. The | inked area. Pressure sensors in the |
| | excess powder in the | vacuum supply are used to measure |
| | non-printed area is | the applied vacuum at the vacuum |
| | removed by | nozzle and a controller is used to |
| | transporting the web | maintain the desired vacuum level |
| | under a vacuum | setpoint by adjusting the position of |
| | nozzle. | a butterfly valve in the vacuum |
| | | supply line. |
| Cutting | The desired pattern for | The web of substrate must be cut in |
| | each layer is printed in | a repeatable location so that when |
| | sequence on the web | the resulting layers are stacked the |
| | of substrate. Each | desired To control the cutting |
| | layer must be | location a fiducial mark was printed |
| | separated into an | at the printing station. A mark |
| | individual sheet from | sensor is used to read the location |
| | the continuous web | of that mark which was printed a |
| | and prepared for | known desired distance from the |
| | stacking. A cutter is | desired point of cutting. The mark |
| | used to cut the web in | sensor sends a signal when the |
| | an interstitial zone | fiducial mark is read to the precut |
| | between each layer | transport controller which then |
| | printed on the web to | transports the web to right position |
| | form the individual | for cutting. The transport process |
| | sheets which are ready | using rollers connected to the shaft |
| | for stacking. | of motor with an encoder. The |
| | | desired encoder position for the cut |
| | | is set and the motor current is |
| | | controlled while the encoder |
| | | position is continuously read to |
| | | transport the substrate web to the |
| | | desired cut location where it is |
| | | stopped and the cutter triggered. |
| | | The cutter is controlled through a |
| | | pneumatic valve which supplies air |
| | | to a pneumatic cylinder controlling |
| | | the cut motion. |
| Post Cut | After the web of | The cut sheet is transported through |
| Transport | substrate has been cut | rollers connected to the shafts of |
| | the resulting sheet of | motors. To get to the stacker in time |
| | material must be | and get out of the way of the next |
| | transported to the | sheet a desired motion profile must |
| | stacker in a timely | be achieved. The motor controllers |
| | fashion to both be put | are given their desired motion |
| | on the stack and get | profiles and using the motor current |
| | out of the way of the | as the output and an encoder sensor |
| | next sheet to be cut | attached to each motor shaft as the |
| | from the web. | input the controller continuously |
| | | monitors the motor position and |
| | | adjust the current accordingly to |
| | | achieve the desired motion profile. |
| Stacking | Sheets are fed into | The sheet is fed into the stacker by |
| | slots on a rotary disc | the post cut transport using the |
| | stacker which through | desired motion profile. There is a |
| | repeated rotary motion | sensor which detects when the |
| | stacks each sheet cut | trailing edge of the sheet has |
| | from the substrate web | entered the disc stacker, this |
| | on top of the previous | triggers a 180-degree rotation of the |
| | sheet. | disc stacker which physically ejects |
| | | and stacks that sheet on top of the |
| | | previous sheet. That rotation is |
| | | controlled through a motor and |
| | | encoder connected to a controller |
| | | which controls motor current |
| | | continuously to achieve the desired |
| | | 180-degree rotation as measured by |
| | | the encoder. An addition control |
| | | loop is used to control the vertical |
| | | position of the stack so that each cut |
| | | sheet of substrate is ejected on top |
| | | of the previous and does not either |
| | | stub on the existing stack or be to far |
| | | away from the stack as it falls onto |
| | | the top of the stack - which might |
| | | create stack positional errors. This |
| | | control loop uses a laser distance |
| | | sensor to continuously monitor the |
| | | position of the top of the stack and |
| | | maintain that desired position for the |
| | | top of the stack even as sheets are |
| | | added to the stack. It achieves this |
| | | function by continuously monitoring |
| | | the laser distance sensor and |
| | | lowering the bottom plate that the |
| | | stack sits on using a motor with an |
| | | encoder connected to lead screw. |
| | | The controller calculates the desired |
| | | top of the stack position and |
| | | determines the appropriate desired |
| | | motor rotation to move the top of the |
| | | stack to the desired location. Using |
| | | that input a motor with an encoder |
| | | has its current controlled to move |
| | | the appropriate rotation. |
| Press Jig | Once a print job is | After stacking is completed on top of |
| Assembly and | completed and all the | the press jig base plate the press jig |
| Transport | individual layers have | base plate is vertically lowered onto |
| | been stacked on top of | a horizontal transport which moves |
| | a press jig base plate, | the press jig and associated stack to |
| | the complete assembly | the location of the press jig removal |
| | and positioning of the | door on the printer. The vertical |
| | entire press jig for | lowering occurs using the same |
| | removal from the | motor and encoder and lead screw |
| | printer must be | for stack height control. However, |
| | completed by | now the controller simply drives the |
| | transporting the stack | motor at a desired velocity |
| | and press jig to the | (measuring encoder position and |
| | removal location in the | controlling motor current) to lower |
| | printer and the press jig | the press jig base plate until a limit |
| | top placed on the stack | switch is reached indicating that the |
| | completing the press jig | lowest point of motion has been |
| | assembly. | achieved. At that position the press |
| | | jig base plate is now resting on the |
| | | supports for the horizontal transport. |
| | | The horizontal transport is then |
| | | triggered which uses a motor and a |
| | | lead screw to transport the press jig |
| | | base plate and the stack resting on |
| | | that horizontally to the door for |
| | | removal from the printer. The |
| | | horizontal transport velocity is |
| | | controlled at the desired rate using a |
| | | motor encoder as input and motor |
| | | current as input. The transport |
| | | motion is completed when a limit |
| | | switch is triggered indicating that the |
| | | press jig base plate is in front of the |
| | | exit door. Finally, the press jig top |
| | | plate is lowered onto the press jig |
| | | and lowered on to the top of the |
| | | stack of layered sheets. The velocity |
| | | of the lowering is controlled at one |
| | | lowering rate before near contact |
| | | with the stack of sheets and at |
| | | another slower velocity after near |
| | | contact with the stack to both |
| | | minimize the time for the entire |
| | | maneuver as well as any |
| | | disturbance to the stack position. |
| | | The desired transport velocity |
| | | control is achieved through |
| | | feedback control using, as an input, |
| | | an encoder attached to the motor |
| | | shaft and as the input the motor |
| | | torque. |
| Waste sheet | Waste sheets are | The waste sheet controller is |
| control | sheets that have been | informed by the system controller |
| | cut from the web of | when to activate and transport |
| | substrate but are not a | sheets into the waste tray. This |
| | desired part of the | controller actuates a motor with |
| | desired 3D print run. | opens a diverter gate which |
| | Waste sheets are | physically blocks the sheet from |
| | typically generated in | moving into the stacker pre- |
| | two scenarios. The first | transport and directs it into the |
| | are the initial set of | waste tray. The input is a signal |
| | sheets when a new | from the system controller that the |
| | print job is started. This | waste diverter gate should open, |
| | initial set of sheets are | and the stepper motor actuates the |
| | not printed on as the | desired number of steps to move the |
| | printer is achieving | diverter gate to the right position. |
| | stable speed and | When the system controller then |
| | position control of the | sends the signal to stop sending |
| | web as the job starts. | sheets to the waste tray the steeper |
| | The second scenario is | motor reverses the motion that |
| | if the image quality | opened the diverter gate, and it is |
| | computer vision system | then closed. |
| | controller detects a bad | |
| | printed layer. In that | |
| | case, the system | |
| | controller will instruct | |
| | the waste sheet | |
| | controller to put the bad | |
| | sheet and any already | |
| | following printed layers | |
| | following the bad sheet | |
| | into the waste area. | |
| Image Quality | If the layer did not print | A line scan camera captures an |
| Control System | as desired, this | image of each layer immediately |
| | controller informs the | after it is printed and that actual |
| | system controller so | printed image is compared to the |
| | that the layer can be | desired printed image. If the |
| | not placed on the stack | differences are significant then the |
| | and instead put in the | controller informs the systems |
| | waste tray and the | controller that the image is “bad”. |
| | layer reprinted so that | |
| | only good layers are | |
| | placed on the stack. | |
| System controller | The system controller | The system controller monitors |
| | monitors and controls | multiple watch dog timers and |
| | over all system timing, | communication signals from the |
| | monitors multiple | individual controllers to watch for |
| | sensors and the | error conditions including non- |
| | individual controllers to | responsive controllers. Additionally, |
| | determine if an error | it monitors multiple sensors through |
| | condition exists. | the printer to detect situations such |
| | Additionally, it | as bad layer image quality, sheet |
| | configures the | jams or out of range conditions. In |
| | individual controllers | those situations, it will appropriately |
| | with the appropriate | implement corrective actions such |
| | parameters and | as directing bad sheets to the waste |
| | provides real time | sheet area and reprint the |
| | instructions to the | necessary sheets to produce a |
| | individual controllers as | good, completed job or if necessary |
| | necessary to | shut down the system and inform |
| | successfully complete | the operator of error conditions |
| | the print job or if | through the UI. It will also monitor |
| | required shutdown the | the sensors measuring whether the |
| | machine and inform the | printer needs the operator to add |
| | operator of necessary | more ink, powders or substrate and |
| | operator actions. | will inform the operator through the |
| | | UI. And at machine startup and job |
| | | start-up it will inform the individual |
| | | controllers of the necessary |
| | | configuration information including |
| | | the desired setpoint information for |
| | | all of the individual controllers. |

FIG. 12 is a flowchart illustrating the process for defect detection, discard, and reprinting of substrate sheets in a composite-based additive manufacturing system. This process ensures that only defect-free layers are included in the final stack, thereby maintaining the integrity and precision of the manufactured 3D object.

The process begins with the step “Camera Detects Next Layer,” where a camera system identifies the arrival of the next substrate layer for inspection. Once the layer is detected, the system proceeds to “Increment Layer Counter,” which updates the layer count to track the sequence of layers being processed.

Next, the step “Capture Layer Image” involves the camera capturing a high-resolution image of the substrate layer. This image is then compared to the original intended image in the step “Compare Layer Image to Original.” The comparison is performed by the vision system controller, which analyzes the captured image for deviations or defects relative to the original design. If the captured image meets the required quality standards at the decision point “Is Image Good?”, the process loops back to the beginning, allowing the system to proceed with the next layer. If the image is found to be defective, the process transitions to corrective actions.

In the event of a defective image, “Tell print controller to begin reprinting at image number (layer counter-1)” indicates the print controller is instructed to reprint the defective layer and any subsequent layers that were printed after the defective one. This ensures that the sequence of layers remains intact and accurate. Simultaneously, the system executes the step “Inform Operator of Bad Layer Thru UI,” where the operator is notified of the defect via the user interface. This notification allows the operator to monitor the issue and take any necessary manual actions.

“Trigger waste tray diverter gate when bad layers pre-stacker transport,” activates the waste tray diverter gate. This mechanism redirects the defective layer and any subsequent layers printed after the defective layer away from the stacking station. These layers are physically removed from the production process, as indicated at the step “Eject bad layer and already printed layers behind the bad layer into the waste tray” and deposited into the waste tray for disposal. The step “Reset waste tray diverter gate to off” deactivates the waste tray diverter gate, allowing the system to resume standard operation for subsequent layers. The process then loops back to the beginning, prepared to inspect the next layer.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

As hereinbefore described, the overall system takes care to ensure optimal registration of sheets in the final build block, to optimize and ensure integrity of the final 3D object. Operating in combination and synergistically, features to serve these goals include image-to-corner registration within a future sheet area, considering both the process/cross-process direction and the inboard/outboard direction; sheet-to-sheet edge registration as facilitated by perpendicular high quality tamping at the stacking area; and placement of a load on the completed stack in the form of a lid which is then pressed, to make stacked and immobile sheet edge-to-sheet edge registration. None of these features, measures or goals are contemplated or required in conventional graphic arts or text printing, yet they are central in the present CBAM 3D printing context.

It should be understood, of course, that the foregoing relates to exemplary embodiments of the subject disclosure and that modifications may be made without departing from the spirit and scope of the subject disclosure as set forth in the following claims.

We claim:

1. An apparatus for composite-based additive manufacturing, comprising:
an unwinding station configured to feed a web of substrate material from a web roll at a controlled speed in a process direction, comprising at least one powered roller;
an edge and corner alignment module positioned downstream of the unwinding station; and
a printing, powdering, and vacuuming station positioned downstream of the edge and corner alignment module;
a cutting station positioned either downstream or upstream of the printing, powdering, and vacuuming station to cut sheets from the web of substrate material with a cut in the inboard-outboard direction;
a stacking station positioned downstream of the printing, powering, and vacuuming station that deposits sheets in a stack, and that comprises at least one tamper that touches a most recently deposited sheet to ensure its edge and corner alignment with the stack;
whereby the apparatus is configured to maintain continuous web transport and precise edge and corner registration of sheets.

2. The apparatus of claim 1, wherein the edge and corner alignment module comprises:
a belt steering system including an edge sensor and a controlled actuator configured to adjust the lateral position of the web of substrate material to maintain edge alignment;
a web cleaning system configured to remove loose fibers from the web of substrate material;
a load cell system including a movable roller and a load cell configured to measure and provide feedback on web tension; and
a velocity sense system including a roller surface encoder configured to measure the velocity of the web of substrate material.

3. The apparatus of claim 1, wherein the cutting system is downstream of the printing, powdering, and vacuuming module, and the printing, powdering, and vacuuming module comprises:
a camera edge sense system configured to detect the position of an edge of the web of substrate material and provide feedback for image placement;
a page wide inkjet head system configured to continuously print cross-sectional images and fiducial marks onto the moving web of substrate material;
a powder deposition system configured to apply powder to the printed web of substrate material;
a smoothing blade configured to distribute the powder evenly;
a vacuum system configured to remove excess powder from the web of substrate material; and
a scanner camera system configured to capture images of the printed and powdered web, whereby camera images enable quality control and defect detection.

4. The apparatus of claim 1, wherein the inkjet head system comprises a plurality of staggered inkjet heads, each head configured to overlap in printable regions with adjacent heads, and wherein the system is configured to perform defect correction by enabling one inkjet head to print in the original area of another inkjet head in response to detected malfunctions or degradations.

5. The apparatus of claim 1, further comprising a fresh-powder container, a vacuum nozzle configured to move downward in a spiral path within the container to extract powder, and a powder-level sensor configured to detect the level of powder and actuate the vacuum nozzle's downward spiral movement in response to the detected level.

6. An apparatus for composite-based additive manufacturing, comprising:
an intermittent powered roller configured to receive a web of substrate material and advance the web in a process direction;
a sensor positioned downstream of the intermittent powered roller, the sensor configured to detect a fiducial mark printed on the web of substrate material;
a cutter positioned downstream of the sensor, the cutter configured to sever the web of substrate material into individual substrate sheets in response to a signal from the sensor;
an accumulator system positioned upstream of the intermittent powered roller and configured to buffer parts of the web of substrate material that remains upstream of the intermittent powered roller, during intermittent advancement and pausing of the web at the intermittent powered roller;
a defect detection system configured to inspect each substrate sheet for defects after printing;
a rejection system operatively connected to the defect detection system and configured to divert a defective substrate sheet away from the process direction, as well as to divert a sufficient number of non-defective substrate sheets away from the process direction until arrival of a nondefective version of the defective substrate sheet;
a stacking station positioned downstream of the cutter that deposits sheets in a stack, and that comprises at least one tamper that touches a most recently deposited sheet to ensure its edge and corner alignment with the stack; and
a controller operatively connected to the intermittent powered roller, the sensor, the cutter, the defect detection system, the rejection system, and the stacking station, the controller being configured to coordinate the advancement, cutting, defect detection, rejection, and stacking of substrate sheets to produce an edge and corner registered stack with sheet-to-sheet registration.

7. The apparatus of claim 6, wherein the stacking station comprises:
a plurality of stacker disks, each stacker disk having a variable slot angle along at least a portion of its circumference to reduce bowing of substrate sheets during stacking; and
an elevator system configured to lower a support surface as the substrate sheets are stacked.

8. The apparatus of claim 6, further comprising a dancer roller, a powered roller, and a tension sensor arranged to maintain and control tension in the web of substrate material as it is transported through the apparatus.

9. The apparatus of claim 6, wherein the controller is further configured to initiate reprinting of any substrate sheet representing a cross-sectional slice of an object that is identified as defective, to start further printing after the reprinted sheet in the order of the next adjacent cross-sectional slice, and to ensure that the reprinted sheet is stacked in the correct order without stacking of the defective substrate sheet or any other sheets created between it and the reprinted sheet, to maintain an intended sequence of layers.

10. The apparatus of claim 7, wherein the stacking station further comprises a slotted back wall configured to allow the stacker disks to pass through and rotate unimpeded during stacking operations.

11. The apparatus of claim 7, further comprising an edge sensor positioned upstream of the stacking station, the edge sensor configured to detect the trailing edge of each substrate sheet and, in response, cause the stacker disks to rotate and deposit the sheet onto the stack.

12. The apparatus of claim 6, further comprising a press jig assembly station comprising a servo-controlled horizontal lead screw configured to move a stack resting on a bottom plate of a press jig horizontally to a removal position, and a servo-controlled vertical lead screw configured to lower a cover onto the stack to immobilize substrate sheets prior to removal, such that the press jig is covered on both top and bottom for transport.

13. A method for continuous composite-based additive manufacturing, the method comprising:
feeding a web of substrate material from a web roll at a controlled speed in a process direction;
aligning the lateral position of the web of substrate material by advancing the web through a powered roller and a passive roller, and adjusting the web position using a belt steering system with an edge sensor and a controlled actuator to maintain edge alignment;
measuring and providing feedback on web tension with a load cell system including a movable roller and a load cell, and adjusting web tension in response to the feedback;
measuring the velocity of the web of substrate material with a roller surface encoder;
detecting the position of an edge of the web of substrate material with a camera edge sense system and providing feedback for image placement;
continuously printing cross-sectional images and fiducial marks onto the moving web of substrate material with an inkjet head system;
applying powder to the printed web of substrate material with a powder deposition system; and
capturing images of the printed and powdered web for quality control and defect detection with a scanner camera system;
cutting substrate material into sheets each containing an image and a fiducial mark;
depositing each sheet onto a stack while maintaining sheet-to-sheet registration and alignment using a tamper;
wherein the method maintains continuous web transport and precise edge and corner registration.

14. The method of claim 13, further comprising removing loose fibers from the web of substrate material using a web brush system.

15. The method of claim 13, further comprising distributing the powder with a smoothing blade.

16. The method of claim 13, further comprising cleaning inkjet heads of the inkjet head system in response to a captured image of the printed and powdered web indicative of a degraded inkjet head in need of cleaning.

17. The method of claim 13, further comprising detecting a malfunction in one inkjet head and compensating by using an adjacent inkjet head to print in the original area of the malfunctioning head, utilizing the staggered arrangement of the inkjet heads to maintain image quality.

18. A method for composite-based additive manufacturing, the method comprising:
detecting a fiducial mark printed on a web of substrate material with a sensor positioned upstream of a cutter;
in response to detecting the fiducial mark, actuating an intermittent powered roller to pause advancement of the web and operating the cutter to sever the web into a plurality of individual substrate sheets;
buffering the web of substrate material upstream of the intermittent powered roller with an accumulator system during intermittent advancement and pausing;
inspecting each individual substrate sheet for defects using a defect detection system, and creating a first reprinted substrate sheet to replace any defective sheet;
creating at least one subsequent reprinted sheet to replace any between the defective sheet and the first reprinted substrate sheet;
diverting the defective substrate sheet and each sheet between the defective sheet and the first reprinted substrate sheet, away from a stacking station using a rejection system;
advancing each non-defective substrate sheet to a stacking station positioned downstream of the cutter;
stacking the non-defective substrate sheets in the stacking station, such that fiber entanglement holds sheets immobile in a vertical stack;
engaging a tamper mechanism to achieve edge-to-edge and corner registration of the stacked substrate sheets;
transferring the registered stack of substrate sheets to a press jig assembly station and applying compressive force and heat to fuse the stack into a build block; and
removing unprinted and unpowdered substrate material from the build block to yield a composite-based three-dimensional object.

19. The method of claim 18, further comprising lowering a support surface in the stacking station with an elevator system as substrate sheets are stacked.

20. The method of claim 18, further comprising maintaining web tension by passing the web over a dancer roller, adjusting a powered roller, and monitoring tension with a sensor to provide feedback for tension control.

21. The method of claim 18, further comprising reprinting any substrate sheet identified as defective by the defect detection system and advancing the reprinted sheet to the stacking station in the correct sequence, such that the stack contains substrate sheets in the intended order for the composite-based three-dimensional object.

22. The method of claim 18, further comprising detecting the trailing edge of each substrate sheet with an edge sensor and, in response, actuating the stacker disks to rotate and deposit the sheet onto the stack.

23. The method of claim 18, comprising moving the web and substrate sheets downstream from printing to stacking without a roller or movement device touching a printed area of a substrate sheet.

24. A composite-based additive manufacturing system, comprising:
a continuous roll of substrate material web;
edge alignment module comprising an edge sensor and a belt steering system;
a roller surface encoder;
an inkjet printing module;
a powder deposition module;
a smoothing blade mechanism;
a controlled vacuum module;
a fiducial mark sensor;
an intermittent powered roller;
an accumulator system;
a pneumatic cutter;
a stacking station positioned downstream of the cutter that deposits sheets in a stack, and that comprises at least one tamper that touches a most recently deposited sheet to ensure its edge and corner alignment with the stack;
a press jig assembly module;
at least one processor or controller; and
at least one memory storing instructions which, when executed by the at least one processor or controller, cause the at least one processor or controller to control a web-based composite-based additive manufacturing system, the instructions causing the processor or controller to:
unwind the continuous roll of substrate material web at a predetermined speed along a process direction;
obtain lateral position data from the edge sensor and, based on the data, adjust the web's lateral position via the belt steering system to maintain precise edge alignment;
determine the web's velocity by processing signals from the roller surface encoder and, in response, control the inkjet printing module to print a cross-sectional image and a fiducial mark onto the moving web;
actuate the powder deposition module to deposit a thermoplastic powder over the printed image and control the smoothing blade mechanism to uniformly distribute the deposited powder;
operate the controlled vacuum module to remove excess and unadhered powder from the printed web;
detect the fiducial mark using the fiducial mark sensor and, upon detection, control the intermittent powered roller to momentarily pause web advancement by engaging the accumulator system and then actuate the pneumatic cutter to sever the web into individual substrate sheets;
coordinate the stacking station to achieve edge-to-edge and corner registration of the substrate sheets into a registered stack; and
direct transfer of the registered stack to the press jig assembly module;
whereby the registered stack may be processed further to produce a composite-based three-dimensional object.
